(19) United States
(12) Patent Application Publication
(10) Pub. No.: US 2016/0197369 A1
(43) Pub. Date: Jul. 7, 2016

(54) MEMBRANE ELECTRODE ASSEMBLY AND FUEL CELL COMPRISING THE SAME

(71) Applicant: SHOWA DENKO K.K., Minato-ku, Tokyo (JP)

(72) Inventors: Kunchan LEE, Minato-ku, Tokyo (JP); Yoshinori ABE, Minato-ku, Tokyo (JP); Yuji ITO, Minato-ku, Tokyo (JP)

(73) Assignee: SHOWA DENKO K.K., Minato-ku, Tokyo (JP)

(21) Appl. No.: 14/410,191

(22) PCT Filed: Jul. 22, 2013
(86) PCT No.: PCT/JP2013/069828

§ 371 Date: Dec. 22, 2014

(30) Foreign Application Priority Data
Jul. 25, 2012 (JP) 2012-165166

(51) Int. Cl. H01M 8/1004; H01M 8/1016; H01M 4/92; H01M 8/1011

(52) U.S. Cl. CPC H01M 8/1004; H01M 8/1011; H01M 8/1016; H01M 4/925; H01M 2008/1095

(57) ABSTRACT

A membrane electrode assembly which includes an anode, a cathode and a solid polymer electrolyte membrane that are specifically arranged, wherein the cathode has a cathode catalyst layer and a cathode diffusion layer that is arranged on a surface of the cathode catalyst layer, the surface being on the side opposite the solid polymer electrolyte membrane side, the cathode catalyst layer contains an oxygen reduction catalyst composed of composite particles each of which is constituted of a catalyst metal containing palladium or a palladium alloy and a catalyst carrier containing, as constituent elements, a specific transition metal element M1, a transition metal element M2 other than the transition metal element M1, carbon, nitrogen and oxygen in a specific ratio, and the cathode diffusion layer contains an oxidation catalyst and a water-repellent resin.

### TECHNICAL FIELD

The present invention relates to a fuel cell from which a small amount of a reaction intermediate is discharged, and a membrane/electrode assembly used in the fuel cell.

### BACKGROUND ART

A fuel cell is a generator which is constituted of at least a solid or liquid electrolyte and two electrodes that induce a desired electrochemical reaction, namely, an anode and a cathode and which directly converts chemical energy of the fuel into electric energy with high efficiency.

Of such fuel cells, a fuel cell using a solid polymer electrolyte membrane as an electrolyte membrane and using hydrogen as a fuel is called a polymer electrolyte fuel cell (PEFC), and a fuel cell using methanol as a fuel is called a direct methanol fuel cell (DMFC). Of these, DMFC using a liquid fuel has a high volume energy density of a fuel, and therefore, it has been paid attention as a small-sized effective transportable or portable power source.

In DMFC, a methanol crossover phenomenon that methanol supplied to the anode permeates through the solid polymer electrolyte and reaches the cathode takes place. The methanol having moved to the cathode is oxidized by oxygen supplied to the cathode and is discharged as carbon dioxide. In this oxidation reaction process, an oxidation reaction intermediate such as formic acid or formaldehyde is not a little produced and discharged from the fuel cell.

As a technique to remove formic acid or formaldehyde that is a reaction intermediate discharged from the cathode, there is, for example, a technique of providing a filter having a by-product gas absorbent in a cathode exhaust gas pipe, as described in Patent Document 1. Moreover, there is a technique of providing a filter containing a decomposition catalyst for a reaction intermediate in an exhaust gas pipe, as described in Patent Document 2.

### CITATION LIST

### Patent Documents

Patent Document 1: JP-A-2008-210796

Patent Document 2: JP-A-2005-183014

Patent Document 3: JP-A-2011-076815

### SUMMARY OF INVENTION

### Technical Problem

In the technique of providing an absorbent, however, there is a limitation on the amount adsorbed by the absorbent, so that it is difficult to obtain a reaction intermediate removal effect over a long period of time. In the technique of providing a catalyst filter in an exhaust gas pipe, the filter becomes flowing resistance for the exhaust gas, and therefore, the capacity of a blower needs to be increased, and a loss attributable to an auxiliary power is great. If such a technique is used as a main method to remove the reaction intermediate, efficiency of the fuel cell system is sometimes lowered.

In order to solve such problems as above, a method for removing the reaction intermediate discharged from the cathode by introducing an oxidation catalyst into the cathode diffusion layer of the fuel cell has been attempted in Patent Document 3. Nevertheless, the amount of the reaction intermediate discharged could not be decreased sufficiently.

Accordingly, it is an object of the present invention to provide a fuel cell system in which the influence of a fuel cell on the system efficiency is small and the amount of a reaction intermediate discharged is small over a long period of time.

### Solution to Problem

The present invention relates to the following [1] to [9].

[1]

A membrane electrode assembly comprising an anode, a cathode and a solid polymer electrolyte membrane and having constitution in which the solid polymer electrolyte membrane is interposed between the anode and the cathode, wherein

the cathode has a cathode catalyst layer and a cathode diffusion layer that is arranged on a surface of the cathode catalyst layer, said surface being on the opposite side to the solid polymer electrolyte membrane side,

the cathode catalyst layer contains an oxygen reduction catalyst composed of composite particles each of which is constituted of a catalyst metal and a catalyst carrier,

the catalyst metal contains palladium or a palladium alloy,

the catalyst carrier contains, as constituent elements,

a transition metal element M1 that is at least one selected from the group consisting of titanium, zirconium, niobium and tantalum,

a transition metal element M2 other than the transition metal element M1,

carbon,

nitrogen, and

oxygen,

the ratio of the number of atoms among the transition metal element M1, the transition metal element M2, carbon, nitrogen and oxygen (transition metal element M1:transition metal element M2:carbon:nitrogen:oxygen) is (1-a):a:x:y:z (with the proviso that a, x, y and z are numbers of 0<a≦0.5, 0<x≦7, 0<y≦2 and 0<z≦3), and

the cathode diffusion layer contains an oxidation catalyst and a water-repellent resin.

[2]

The membrane electrode assembly as stated in the above [1], wherein the transition metal element M2 is at least one selected from iron, nickel, chromium, cobalt, vanadium and manganese.

[3]

The membrane electrode assembly as stated in the above [1] or [2], wherein the oxidation catalyst contained in the cathode diffusion layer is at least one selected from platinum, palladium, copper, silver, tungsten, molybdenum, iron, nickel, cobalt, manganese, zinc and vanadium.

[4]

The membrane electrode assembly as stated in any one of the above [1] to [3], wherein the water-repellent resin contained in the cathode diffusion layer is at least one selected from polytetrafluoroethylene, polychlorotrifluoroethylene, poly(vinylidene fluoride), poly(vinyl fluoride), a perfluoroalkoxyfluorine resin, a tetrafluoroethylene/hexafluoropropylene copolymer, an ethylene/tetrafluoroethylene copolymer, an ethylene/chlorotrifluoroethylene copolymer, polyethylene, polyolefin, polypropylene, polyaniline, polythiopheneandpolyester.

[5]

The membrane electrode assembly as stated in any one of the above [1] to [4], wherein the cathode catalyst layer further contains an electron conductive substance.

[6]

A fuel cell comprising the membrane electrode assembly as stated in any one of the above [1] to [5].

[7]

The fuel cell as stated in the above [6], which further comprises a reaction intermediate removing filter for a direct liquid fuel cell, said reaction intermediate removing filter being for removing a reaction intermediate contained in a discharged matter from the electrode.

[8]

The fuel cell as stated in the above [7], wherein the reaction intermediate removing filter for a direct liquid fuel cell comprises:

a gas-liquid separation member for selectively allowing a gas component in the discharged matter to permeate therethrough, and

a catalyst part for allowing the gas component having permeated through the gas-liquid separation member to undergo oxidation combustion.

[9]

The fuel cell as stated in any one of the above [6] to [8], which is a direct methanol fuel cell.

A fuel is electrochemically oxidized in the anode catalyst layer, and oxygen is reduced in the cathode catalyst layer, so that a difference in electrical potential is produced between those electrodes. When a load is placed between the electrodes as an external circuit at this time, ionic migration occurs in the electrolyte, and electrical energy is taken out into the external load.

### Advantageous Effects of Invention

There is provided by the present invention a fuel cell system in which the influence on the system efficiency is small and the amount of a reaction intermediate discharged is small over a long period of time.

### BRIEF DESCRIPTION OF DRAWINGS

FIG. 1 is a sectional schematic view of a membrane electrode assembly used in the fuel cell of the present invention.

FIG. 2 is an enlarged sectional schematic view of a cathode diffusion layer used in the fuel cell of the present invention.

FIG. 3 is an enlarged sectional schematic view of a cathode diffusion layer used in the fuel cell of the present invention.

FIG. 4 is a sectional schematic view of another embodiment of a membrane electrode assembly used in the fuel cell of the present invention.

FIG. 5 is a sectional schematic view of the fuel cell of the present invention.

FIG. 6 is a sectional schematic view showing an example of a reaction intermediate removing filter employable in the present invention.

FIG. 7 shows a powder X-ray diffraction spectrum of a carrier (1) obtained in Example 1.

### DESCRIPTION OF EMBODIMENTS

Embodiments of the present invention are shown below.

[Membrane Electrode Assembly]

The membrane electrode assembly used in the fuel cell of the present invention includes an anode, a cathode and a solid polymer electrolyte membrane and has constitution in which the solid polymer electrolyte membrane is interposed between the anode and the cathode.

Here, a case where the fuel cell of the present invention is used as a direct methanol fuel cell (DMFC) using an aqueous methanol solution as a fuel is described, but the fuel cell of the present invention and a membrane electrode assembly used therefor are not limited to those using an aqueous methanol solution as a fuel, and an effect of depressing the amount of a discharged reaction intermediate is obtained as long as the fuel cell used is a fuel cell using, as a fuel, an aqueous solution containing an organic substance, such as an aqueous ethanol solution fuel. The “reaction intermediate” intended in the present invention is, in a wide sense, a chemical species that may be formed, on the basis of a fuel introduced into the anode, in a process of reaching water and/or carbon dioxide from the fuel. In the case of DMFC, a major example of the “reaction intermediate” is an oxidation reaction intermediate that may be formed in an oxidation reaction process of reaching water and carbon dioxide from methanol introduced as a fuel into the anode. Specific major examples of the oxidation reaction intermediates include formic acid, formaldehyde and methyl formate. In the fuel cell, however, independently from the oxidation reaction in the anode, a phenomenon that a part of a fuel introduced into the anode moves to the cathode side, such as a crossover phenomenon, sometimes takes place, and in the cathode, a part of the fuel sometimes undergoes an oxidation reaction similar to that in the anode to form formic acid, formaldehyde and methyl formate that are oxidation reaction intermediates. According to the present invention, such a reaction intermediate is oxidized by an oxidation catalyst contained in the cathode diffusion layer and thereby becomes carbon dioxide, so that the amount of the reaction intermediate discharged is depressed.

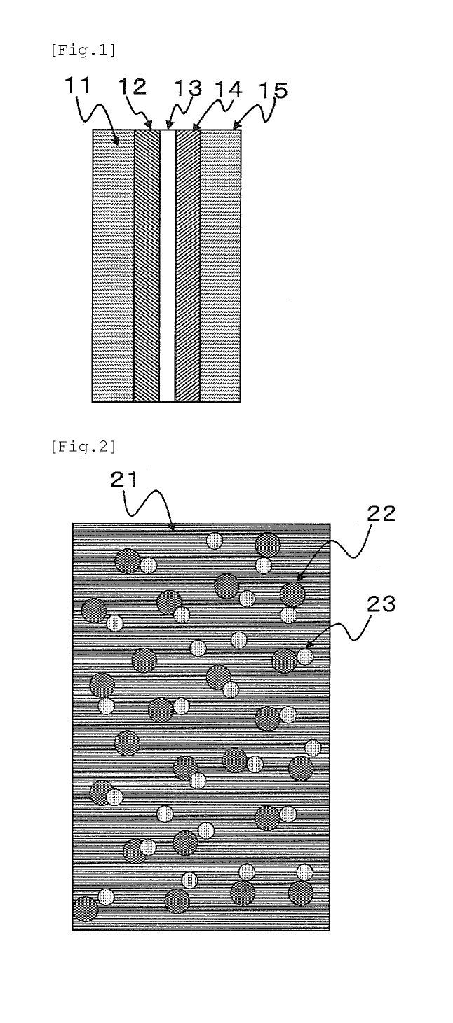

A sectional schematic view of a membrane electrode assembly used in the fuel cell of the present invention is shown in FIG. 1. On both surfaces of a solid polymer electrolyte membrane 13, an anode catalyst layer 12 and a cathode catalyst layer 14 are arranged, and on the outer sides thereof, an anode diffusion layer 11 and a cathode diffusion layer 15 are further arranged. In the present invention, an electrode constituted of the anode catalyst layer 12 and the anode diffusion layer 11 combined together is referred to as an “anode”, and an electrode constituted of the cathode catalyst layer 14 and the cathode diffusion layer 15 combined together is referred to as a “cathode”.

<<Anode Catalyst Layer, Cathode Catalyst Layer>>

As fuel cell catalyst layers to constitute the fuel cell of the present invention, there are an anode catalyst layer 12 and a cathode catalyst layer 14. In the present specification, the anode catalyst layer 12 and the cathode catalyst layer 14 are together generically referred to as a “catalyst layer” in some cases.

The anode catalyst layer 12 includes a catalyst and a solid polymer electrolyte. The catalyst contained in the anode catalyst layer 12 is not specifically restricted provided that it accelerates oxidation reaction of an aqueous methanol solution that is a fuel, and at least one selected from platinum, gold, palladium, iridium, rhodium, ruthenium, iron, cobalt, nickel and the like can be used. In particular, it is preferable to use platinum and ruthenium in a composite form. As the catalyst contained in the anode catalyst layer 12, the same catalyst as used in the later-described cathode catalyst layer 14 can be also used.

The catalyst used in the anode catalyst layer 12 may be supported on a carrier such as carbon black.

The cathode catalyst layer 14 includes an oxygen reduction catalyst and a solid polymer electrolyte. In the present invention, as the oxygen reduction catalyst contained in the cathode catalyst layer 14, a catalyst composed of the later-described composite particles is used. In the present invention, the cathode catalyst layer 14 preferably further contains an electron conductive substance.

<Composite Particle>

The oxygen reduction catalyst used in the cathode catalyst layer 14 in the present invention is composed of composite particles each of which is constituted of a specific catalyst metal and a specific catalyst carrier. The catalyst metal contains palladium or a palladium alloy. The catalyst carrier contains a transition metal element M1, a transition metal element M2, carbon, nitrogen and oxygen as constituent elements, and the ratio of the number of atoms among the transition metal element M1, the transition metal element M2, carbon, nitrogen and oxygen (transition metal element M1:transition metal element M2:carbon:nitrogen:oxygen) is (1-a):a:x:y:z (with the proviso that a, x, y and z are numbers of 0<a≦0.5, 0<x≦7, 0<y≦2 and 0<z≦3). Here, the transition metal element M1 to constitute the catalyst carrier is at least one selected from the group consisting of titanium, zirconium, niobium and tantalum, and the transition metal element M2 is a transition metal element other than the transition metal element M1.

In a preferred embodiment in the present invention, the transition metal element M2 is at least one selected from iron, nickel, chromium, cobalt, vanadium and manganese.

The composite particles for use in the present invention preferably have a mean particle diameter of not less than 10 nm but not more than 500 nm. Here, the mean particle diameter of the composite particles can be measured by a transmission electron microscope.

In the present invention, such a composite particle may be one obtained by any production process as long as it has the above constitution, but it is preferably a composite particle obtained by the production process described below. The reason is that if a composite particle obtained by such a production process is used, not only is the oxygen reduction ability of the supported catalyst metal enhanced but also the composite particle has a property of being hardly corroded though it is high-potential in an acidic electrolyte. That is to say, since the composite particle for use in the present invention has high oxygen reduction ability and has a property of being hardly corroded even if it is high-potential in an acidic electrolyte, it is preferably used as an oxygen reduction catalyst for constituting the cathode catalyst layer 14. However, this composite particle is not limited to a composite particle used as an oxygen reduction catalyst for constituting the cathode catalyst layer 14, and it can be also used as a catalyst for constituting the anode catalyst layer 12.

A production process for a composite particle that is preferably used as an oxygen reduction catalyst for constituting the fuel cell of the present invention is described below.

(Production Process for Composite Particle)

The catalyst carrier to constitute the composite particle used in the present invention is preferably a catalyst carrier obtained by a production process including:

(a) a step of mixing a transition metal compound (1), a nitrogen-containing organic compound (2) and a solvent to give a catalyst carrier precursor solution,

(b) a step of removing the solvent from the catalyst carrier precursor solution, and

(c) a step of heat-treating a solid residue obtained in the step (b) at a temperature of 500 to 1100° C. to give a catalyst carrier,

wherein a part or all of the transition metal compound (1) is a compound containing a transition metal element M1 of the periodic table Group 4 or Group 5 as a transition metal element, and

at least one of the transition metal compound (1) and the nitrogen-containing organic compound (2) has an oxygen atom.

In this case, it is preferable to use, as the “composite particle”, a supported catalyst obtained by a production process including:

a step for producing a catalyst carrier by the above production process for a catalyst carrier, and

(d) a step of allowing the catalyst carrier to support the catalyst metal to give a supported catalyst.

The composite particle for use in the present invention is not limited to a composite particle of such an embodiment that the catalyst carrier and the catalyst metal are separable from each other, and it may be a composite particle in which the catalyst carrier and the catalyst metal are united so as to be inseparable and constitute one composite particle as a whole. In the present invention, therefore, there can be also used, as the “composite particle”, a composite particle obtained by a production process including:

(a) a step of mixing a transition metal compound (1), a nitrogen-containing organic compound (2) and a solvent to give a heat-treated product precursor solution,

(b) a step of removing the solvent from the heat-treated product precursor solution,

(c) a step of heat-treating a solid residue obtained in the step (b) at a temperature of 500 to 1100° C. to give a heat-treated product, and

(d) a step of obtaining a composite catalyst containing the heat-treated product and a catalyst metal,

wherein a part or all of the transition metal compound (1) is a compound containing a transition metal element M1 of the periodic table Group 4 or Group 5 as a transition metal element, and

at least one of the transition metal compound (1) and the nitrogen-containing organic compound (2) has an oxygen atom.

A composite particle obtained by such a production process can be also preferably used in the present invention.

The heat-treated product obtained during the course of the above production process for a composite catalyst can function as a catalyst carrier.

In the present specification, an atom or an ion is described as an “atom” without strictly distinguishing them from each other, unless there are special circumstances.

Step (a)

In the step (a), at least a transition metal compound (1), a nitrogen-containing organic compound (2) and a solvent are mixed to give a heat-treated product precursor solution. This heat-treated product precursor solution is placed as a catalyst carrier precursor solution in the production process for a catalyst carrier in the present invention.

In the step (a), a compound containing fluorine may be further mixed.

As the procedure for mixing, there can be mentioned, for example,

a procedure (i): in one container, a solvent is prepared, then the transition metal compound (1) and the nitrogen-containing organic compound (2) are added to the solvent to dissolve them, and they are mixed, and

a procedure (ii): a solution of the transition metal compound (1) and a solution of the nitrogen-containing organic compound (2) are prepared, and they are mixed.

When solvents having high dissolving power are different for each of the components, the procedure (i) is preferable. When the transition metal compound (1) is, for example, the later-described metal halide, the procedure (i) is preferable, and when the transition metal compound (1) is, for example, the later-described metal alkoxide or metal complex, the procedure (ii) is preferable.

When the later-described first transition metal compound and second transition metal compound are used as the transition metal compounds (1), a preferred embodiment of the procedure (ii) is a procedure (ii′): a solution of the first transition metal compound, a solution of the second transition metal compound and a solution of the nitrogen-containing organic compound (2) are prepared, and they are mixed.

In order to increase a solubility speed of each component in a solvent, the mixing operation is preferably carried out with stirring.

When the solution of the transition metal compound (1) and the solution of the nitrogen-containing organic compound (2) are mixed, it is preferable to feed one solution to the other solution at a constant rate using a pump or the like.

It is also preferable that the solution of the transition metal compound (1) is added to the solution of the nitrogen-containing organic compound (2) little by little (that is, the whole amount is not added at once).

The present inventors assume that a reaction product of the transition metal compound (1) and the nitrogen-containing organic compound (2) is contained in the heat-treated product precursor solution. The solubility of the reaction product in the solvent varies also depending upon a combination of the transition metal compound (1), the nitrogen-containing organic compound (2), the solvent, etc.

On this account, when the transition metal compound (1) is, for example, a metal alkoxide or a metal complex, it is preferable that the heat-treated product precursor solution does not contain a precipitate or a dispersoid, though depending upon the type of the solvent and the type of the nitrogen-containing organic compound (2), and even if such a substance is contained, the amount thereof is small (e.g., not more than 10% by mass, preferably not more than 5% by mass, more preferably not more than 1% by mass, based on the total amount of the solution). Further, the heat-treated product precursor solution is preferably transparent, and for example, the value measured by a measuring method for transparency of a liquid described in JIS K0102 is preferably not less than 1 cm, more preferably not less than 2 cm, still more preferably not less than 5 cm.

On the other hand, when the transition metal compound (1) is, for example, a metal halide, a precipitate which is assumed to be a reaction product of the transition metal compound (1) and the nitrogen-containing organic compound (2) tends to be formed in the heat-treated product precursor solution, though it depends upon the type of the solvent and the type of the nitrogen-containing organic compound (2).

In the step (a), it is also possible that the transition metal compound (1), the nitrogen-containing organic compound (2) and the solvent are placed in a container capable of pressurization, such as an autoclave, and they are mixed while applying a pressure of not lower than normal pressure.

The temperature for mixing the transition metal compound (1), the nitrogen-containing organic compound (2) and the solvent is, for example, 0 to 60° C. Since a complex is presumed to be formed from the transition metal compound (1) and the nitrogen-containing organic compound (2), it is considered that if this temperature is excessively high, the complex is hydrolyzed to form a precipitate of a hydroxide when the solvent contains water, so that an excellent heat-treated product is not obtained, and it is considered that if this temperature is excessively low, the transition metal compound (1) is precipitated before a complex is formed, so that an excellent heat-treated product is not obtained. Here, this “heat-treated product” functions as a catalyst carrier from the viewpoint of the production process for a catalyst carrier in the present invention. From this viewpoint, it is considered that if the temperature for mixing the transition metal compound (1), the nitrogen-containing organic compound (2) and the solvent is excessively high, an excellent catalyst carrier is not obtained, and it is considered that if this temperature is excessively low, an excellent catalyst carrier is not obtained.

It is preferable that the heat-treated product precursor solution does not contain a precipitate or a dispersoid, but the precursor solution may contain them in a small amount (e.g., not more than 5% by mass, preferably not more than 2% by mass, more preferably not more than 1% by mass, based on the total amount of the solution).

The heat-treated product precursor solution is preferably transparent, and for example, the value measured by a measuring method for transparency of a liquid described in JIS K0102 is preferably not less than 1 cm, more preferably not less than 2 cm, still more preferably not less than 5 cm.

Transition Metal Compound (1)

A part or all of the transition metal compound (1) is a compound containing a transition metal element M1 of the periodic table Group 4 or Group 5 as a transition metal element.

As the transition metal elements M1, elements of the periodic table Group 4 and Group 5 can be mentioned, and specifically, titanium, zirconium, niobium and tantalum can be mentioned. From the viewpoints of cost and performance obtained when a catalyst metal is supported on a catalyst carrier, or when viewed from another angle, from the viewpoints of cost and performance of the resulting composite catalyst, preferable are titanium and zirconium among these elements. These elements may be used singly, or may be used in combination of two or more kinds.

The transition metal compound (1) preferably contains at least one selected from an oxygen atom and a halogen atom, and specific examples of such compounds include metal phosphate, metal sulfate, metal nitrate, organic acid metal salt, metal oxyhalide (or intermediate hydrolyzate of metal halide), metal alkoxide, metal halide, metal halogen oxoate, metal hypohalogenite and metal complex. These may be used singly, or may be used in combination of two or more kinds.

As the transition metal compounds (1) having an oxygen atom, metal alkoxide, acetylacetone complex, metal oxychloride and metal sulfate are preferable. From the viewpoint of cost, metal alkoxide and acetylacetone complex are more preferable, and from the viewpoint of solubility in the solvent, metal alkoxide and acetylacetone complex are still more preferable.

As the metal alkoxides, methoxide, propoxide, isopropoxide, ethoxide, butoxide and isobutoxide of the above metal are preferable, and isopropoxide, ethoxide and butoxide of the above metal are more preferable. The metal alkoxide may have one kind of an alkoxide group, or may have two or more kinds of alkoxide groups.

As the metal halides, metal chloride, metal bromide and metal iodide are preferable, and as the metal oxyhalides, the aforesaid metal oxychloride, metal oxybromide and metal oxyiodide are preferable.

Specific examples of the transition metal compounds containing the transition metal element M1 include:

titanium compounds, such as titanium tetramethoxide, titanium tetraethoxide, titanium tetrapropoxide, titanium tetraisopropoxide, titanium tetrabutoxide, titanium tetraisobutoxide, titanium tetrapentoxide, titanium tetraacetylacetonate, titanium oxydiacetylacetonate, tris(acetylacetonato) secondary titanium chloride, titanium tetrachloride, titanium trichloride, titanium oxychloride, titanium tetrabromide, titanium triboromide, titanium oxybromide, titanium tetraiodide, titanium triiodide and titanium oxyiodide;

niobium compounds, such as niobium pentamethoxide, niobium pentaethoxide, niobium pentaisopropoxide, niobium pentabutoxide, niobium pentapentoxide, niobium pentachloride, niobium oxychloride, niobium pentabromide, niobium oxybromide, niobium pentaiodide and niobium oxyiodide;

zirconium compounds, such as zirconium tetramethoxide, zirconium tetraethoxide, zirconium tetrapropoxide, zirconium tetraisopropoxide, zirconium tetrabutoxide, zirconium tetraisobutoxde, zirconium tetrapentoxide, zirconium tetraaceylacetonate, zirconiumtetrachloride, zirconium oxychloride, zirconium tetrabromide, zirconium oxybromide, zirconium tetraiodide and zirconium oxyiodide; and

tantalum compounds, such as tantalum pentamethoxide, tantalum pentaethoxide, tantalum pentaisopropoxide, tantalum pentabutoxide, tantalum pentapentoxide, tantalum tetraethoxyacetylacetonate, tantalumpentachloride, tantalumoxychloride, tantalumpentabromide, tantalum oxybromide, tantalum pentaiodide and tantalum oxyiodide. These may be used singly, or may be used in combination of two or more kinds.

Of these compounds, preferable are:

titanium tetraethoxide, titanium tetrachloride, titanium oxychloride, titanium tetraisopropoxide, titanium tetraacetylacetonate,

niobium pentaethoxide, niobium pentachloride, niobium oxychloride, niobium pentaisopropoxide,

zirconium tetraethoxide, zirconium tetrachloride, zirconium oxychloride, zirconium tetraisopropoxide, zirconium tetraacetylacetonate,

tantalum pentamethoxide, tantalum pentaethoxide, tantalum pentachloride, tantalum oxychloride, tantalum pentaisopropoxide and tantalum tetraethoxyacetylacetonate; and

more preferable are titanium tetraisopropoxide, titanium tetraacetylacetonate, niobium ethoxide, niobium isopropoxide, zirconium oxychloride, zirconium tetraisopropoxide and tantalum pentaisopropoxide,

because the resulting heat-treated product, namely, the resulting catalyst carrier becomes fine particles of uniform particle diameters, and their activities are high.

As the transition metal compound (1), a transition metal compound containing, as a transition metal element, a transition metal element M2 that is different from the transition metal element M1 (said compound being also referred to as a “second transition metal compound” hereinafter) may be used in combination with the transition metal compound containing, as a transition metal element, the transition metal element M1 (said compound being also referred to as a “first transition metal compound” hereinafter). Here, the transition metal element M2 is preferably at least one transition metal element selected from iron, nickel, chromium, cobalt, vanadium and manganese. When the second transition metal compound is used, performance obtained when the catalyst metal is supported on the catalyst carrier is enhanced, or when viewed from another angle, performance of the resulting composite catalyst is enhanced.

From the observation of an XPS spectrum of the heat-treated product, namely, the catalyst carrier, it is presumed that if the second transition metal compound is used, formation of a bond between the transition metal element M1 (e.g., titanium) and a nitrogen atom is promoted, and as a result, performance obtained when the catalyst metal is supported on the catalyst carrier is enhanced, or when viewed from another angle, performance of the composite catalyst is enhanced.

As the transition metal elements M2 in the second transition metal compound, iron and chromium are preferable, and iron is more preferable, from the viewpoint of a balance between cost and performance obtained when the catalyst metal is supported on the catalyst carrier, or when viewed from another angle, from the viewpoint of a balance between cost and performance of the resulting composite catalyst.

Specific examples of the second transition metal compounds include:

iron compounds, such as iron(II) chloride, iron(III) chloride, iron(III) sulfate, iron(II) sulfide, iron(III) sulfide, potassium ferrocyanide, potassium ferricyanide, ammonium ferrocyanide, ammonium ferricyanide, iron ferrocyanide, iron(II) nitrate, iron (III) nitrate, iron(II) oxalate, iron(III) oxalate, iron(II) phosphate, iron(III) phosphate ferrocene, iron(II) hydroxide, iron(III) hydroxide, iron(II) oxide, iron(III) oxide, triiron tetraoxide, iron(II)acetate, iron(II) lactate and iron(III) citrate;

nickel compounds, such as nickel(II) chloride, nickel(II) sulfate, nickel(II) sulfide, nickel(II) nitrate, nickel(II) oxalate, nickel(II) phosphate, nickelocene, nickel(II) hydroxide, nickel(II) oxide, nickel(II) acetate and nickel(II) lactate;

chromium compounds, such as chromium(II) chloride, chromium(III) chloride, chromium(III) sulfate, chromium(III) sulfide, chromium(III) nitrate, chromium(III) oxalate, chromium(III) phosphate, chromium(III) hydroxide, chromium(II) oxide, chromium(III) oxide, chromium(IV) oxide, chromium(VI) oxide, chromium(II) acetate, chromium(III) acetate and chromium(III) lactate;

cobalt compounds, such as cobalt(II) chloride, cobalt(III) chloride, cobalt(II) sulfate, cobalt(II) sulfide, cobalt(II) nitrate, cobalt(III) nitrate, cobalt(II) oxalate, cobalt(II) phosphate, cobaltocene, cobalt(II) hydroxide, cobalt(II) oxide, cobalt(III) oxide, tricobalt tetraoxide, cobalt(II) acetate and cobalt(II) lactate;

vanadium compounds, such as vanadium(II) chloride, vanadium(III) chloride, vanadium(IV) chloride, vanadium(IV) oxysulfate, vanadium(III) sulfide, vanadium(IV) oxyoxalate, vanadium metallocene, vanadium(V) oxide, vanadium acetate and vanadium citrate; and

manganese compounds, such as manganese(II) chloride, manganese(II) sulfate, manganese(II) sulfide, manganese(II) nitrate, manganese(II) oxalate, manganese(II) hydroxide, manganese(II) oxide, manganese(III) oxide, manganese(II) acetate, manganese(II) lactate and manganese citrate. These may be used singly, or may be used in combination of two or more kinds.

Of these compounds, preferable are:

iron(II) chloride, iron(III) chloride, potassium ferrocyanide, potassium ferricyanide, ammonium ferrocyanide, ammonium ferricyanide, iron(II) acetate, iron(II) lactate,

nickel(II) chloride, nickel(II) acetate, nickel(II) lactate,

chromium(II) chloride, chromium(III) chloride, chromium(II) acetate, chromium(III) acetate, chromium(III) lactate,

cobalt(II) chloride, cobalt(III) chloride, cobalt(II) acetate, cobalt(II) lactate,

vanadium(II) chloride, vanadium(III) chloride, vanadium(IV) chloride, vanadium(IV) oxysulfate, vanadium acetate, vanadium citrate,

manganese(II) chloride, manganese(II) acetate and manganese(II) lactate; and

more preferable are iron(II) chloride, iron(III) chloride, potassium ferrocyanide, potassium ferricyanide, ammonium ferrocyanide, ammonium ferricyanide, iron(II) acetate, iron(II) lactate, chromium(II) chloride, chromium(III) chloride, chromium(II) acetate, chromium(III) acetate and chromium(III) lactate.

Nitrogen-Containing Organic Compound (2)

The nitrogen-containing organic compound (2) is preferably a compound that can become a ligand capable of being coordinated to a metal atom in the transition metal compound (1) (preferably a compound that can give a mononuclear complex), and is more preferably a compound that can become a multidentate ligand (preferably a bidentate ligand or a tridentate ligand) (i.e., compound that can give a chelate).

The nitrogen-containing organic compounds (2) may be used singly, or may be used in combination of two or more kinds.

The nitrogen-containing organic compound (2) preferably has functional groups, such as amino group, nitrile group, imide group, imine group, nitro group, amide group, azide group, aziridine group, azo group, isoycanate group, isothiocyanate group, oxime group, diazo group and nitroso group, or rings, such as pyrrole ring, porphyrin ring, imidazole ring, pyridine ring, pyrimidine ring and pyrazine ring (these functional groups and rings are also collectively referred to as “nitrogen-containing molecular groups”).

The present inventors assume that when the nitrogen-containing organic compound (2) has a nitrogen-containing molecular group in a molecule, it can be coordinated to a metal atom derived from the transition metal compound (1) more strongly through the mixing in the step (a).

Of the nitrogen-containing molecular groups, more preferable are amino group, imine group, amide group, pyrrole ring, pyridine ring and pyrazine ring, still more preferable are amino group, imine group, pyrrole ring and pyrazine ring, and particularly preferable are amino group and pyrazine ring because the activity of the catalyst metal supported is particularly enhanced, or when viewed from another angle, because the activity of the composite catalyst is particularly enhanced.

Specific examples of the nitrogen-containing organic compounds (2) (containing no oxygen atom) include melamine, ethylenediamine, triazole, acetonitrile, acrylonitrile, ethyleneimine, aniline, pyrrole and polyethyleneimine. Of these, compounds capable of becoming corresponding salts may be in the form of corresponding salts. Of these, ethylenediamine and ethylenediamine dihydrochloride are preferable because the activity of the catalyst metal supported is enhanced, or when viewed from another angle, because the activity of the resulting composite catalyst is high.

The nitrogen-containing organic compound (2) preferably further has a hydroxyl group, a carbonyl group, an acid halide group, a sulfo group, a phosphoric acid group, a ketone group, an ether group or an ester group (these groups are collectively referred to as “oxygen-containing molecular groups”). The present inventors assume that when the nitrogen-containing organic compound (2) has an oxygen-containing molecular group in its molecule, it can be coordinated to a metal atom derived from the transition metal compound (1) more strongly through the mixing in the step (a).

Of the oxygen-containing molecular groups, a carbonyl group (e.g., carboxyl group or aldehyde group) is particularly preferable because the activity of the catalyst metal supported is particularly enhanced, or when viewed from another angle, because the activity of the resulting composite catalyst is particularly enhanced.

As the nitrogen-containing organic compound (2) containing an oxygen atom in its molecule, a compound having the nitrogen-containing molecular group and the oxygen-containing molecular group is preferable. The present inventors assume that such a compound can be particularly strongly coordinated to a metal atom derived from the transition metal compound (1) through the step (a).

As the compounds having the nitrogen-containing molecular group and the oxygen-containing molecular group, preferable are compounds having an amino group and a carbonyl group and their derivatives, more preferable are compounds in which a nitrogen atom is bonded to a carbon of a carbonyl group, and still more preferable are amino acids.

As the amino acids, alanine, arginine, asparagine, aspartic acid, cysteine, glutamine, glutamic acid, glycine, histidine, isoleucine, leucine, lysine, methionine, phenylalanine, serine, threonine, tryptophan, tyrosine, valine, norvaline, glycylglycine, triglycine and tetaraglycine are preferable. Of these, alanine, glycine, lysine, methionine and tyrosine are more preferable because the activity of the catalyst metal supported is enhanced, or when viewed from another angle, because the activity of the resulting composite catalyst is high. Of these, alanine, glycine and lysine are particularly preferable because the activity of the catalyst metal supported is extremely enhanced, or when viewed from another angle, because the resulting composite catalyst exhibits an extremely high activity.

Specific examples of the nitrogen-containing organic compounds (2) containing an oxygen atom in its molecule include, in addition to the above amino acids, acylpyrroles such as acetylpyrrole, pyrrolecarboxylic acid, acylimdazoles such as acetylimidazole, carbonyldiimidazole, imidazolecarboxylic acid, pyrazole, acetanilide, pyrazinecarboxylic acid, piperidinecarboxylic acid, piperazinecarboxylic acid, morpholine, pyrimidinecarboxylic acid, nicotinic acid, 2-pyridinecarboxylic acid, 2,4-pyridinedicarboxylic acid, 8-quinolinol and polyvinylpyrrolidone. Of these, compounds that can become bidentate ligands, specifically, pyrrole-2-carboxylic acid, imidazole-4-carboxylic acid, 2-pyrazinecarboxylic acid, 2-piperidinecarboxylic acid, 2-piperazinecarboxylic acid, nicotinic acid, 2-pyridinecarboxylic acid, 2, 4-pyridinedicarboxylic acid and 8-quinolinol are preferable, and 2-pirazinecarboxylic acid and 2-pyridinecarboxylic acid are more preferable, because the activity of the catalyst metal supported is enhanced, or when viewed from another angle, because the activity of the resulting composite catalyst is high.

The ratio (B/A) of the number B of all carbon atoms of the nitrogen-containing organic compound (2) used in the step (a) to the number A of all atoms of the metal elements of the transition metal compounds (1) used in the step (a) is preferably not more than 200, more preferably not more than 150, still more preferably not more than 80, particularly preferably not more than 30, because the amount of a component that is released as a carbon compound such as carbon dioxide or carbon monoxide can be decreased in the heat treatment of the step (c), that is, the amount of the exhaust gas can be made small in the production of a heat-treated product capable of functioning as a catalyst carrier. From the viewpoint that the activity of the catalyst metal supported is made excellent, or when viewed from another angle, from the viewpoint that a composite catalyst having excellent activity is obtained, the ratio is preferably not less than 1, more preferably not less than 2, still more preferably not less than 3, particularly preferably not less than 5.

The ratio (C/A) of the number C of all nitrogen atoms of the nitrogen-containing organic compound (2) used in the step (a) to the number A of all atoms of the metal elements of the transition metal compounds (1) used in the step (a) is preferably not more than 28, more preferably not more than 17, still more preferably not more than 12, particularly preferably not more than 8.5, from the viewpoint of obtaining a composite catalyst of excellent activity. From the viewpoint that the activity of the catalyst metal supported is made excellent, or when viewed from another angle, from the viewpoint that a composite catalyst having excellent activity is obtained, the ratio is preferably not less than 1, more preferably not less than 2.5, still more preferably not less than 3, particularly preferably not less than 3.5.

When the ratio between the first transition metal compound and the second transition metal compound used in the step (a) (in terms of a molar ratio (M1:M2) of atoms between the transition metal element M1 and the transition metal element M2) is represented by M1:M2=(1-a′):a′, the range of a′ is 0<a′≦0.5, preferably 0.01≦a′≦0.5, more preferably 0.02≦a′≦0.4, particularly preferably 0.05≦a′≦0.3.

<Solvent>

Examples of the solvents include water, alcohols and acids. As the alcohols, ethanol, methanol, butanol, propanol and ethoxyethanol are preferable, and ethanol and methanol are more preferable. As the acids, acetic acid, nitric acid, hydrochloric acid, an aqueous phosphoric acid solution and an aqueous citric acid solution are preferable, and acetic acid and nitric acid are more preferable. These may be used singly, or may be used in combination of two or more kinds.

When the transition metal compound (1) is a metal halide, methanol is preferable as the solvent.

<Suspending Agent>

When the transition metal compound (1) is a compound containing a halogen atom, such as titanium chloride, niobium chloride, zirconium chloride or tantalum chloride, such a compound is generally readily hydrolyzed by water and liable to cause a precipitate of hydroxide, oxychloride or the like. Therefore, when the transition metal compound (1) contains a halogen atom, it is preferable to add a strong acid in an amount of not less than 1% by mass. If the acid is, for example, hydrochloric acid, the acid is added so that the concentration of hydrogen chloride in the solution may be not less than 5% by mass, more preferably not less than 10% by mass, whereby formation of a precipitate derived from the transition metal compound (1) is inhibited and a transparent heat-treated product precursor solution, namely, a transparent catalyst carrier precursor solution can be obtained.

Also in the case where the transition metal compound (1) is a metal complex and water is used singly or in combination with another compound, as the solvent, it is preferable to use a suspending agent. As the suspending agents in this case, preferable are compounds having a diketone structure, more preferable are diacetyl, acetylacetone, 2,5-hexanedione and dimedone, and still more preferable are acetylacetone and 2,5-hexanedione.

The suspending agent is added so that the amount thereof in 100% by mass of the metal compound solution (solution containing the transition metal compound (1) but not containing the nitrogen-containing organic compound (2)) may preferably be 1 to 70% by mass, more preferably 2 to 50% by mass, still more preferably 15 to 40% by mass.

The suspending agent is added so that the amount thereof in 100% by mass of the heat-treated product precursor solution may preferably be 0.1 to 40% by mass, more preferably 0.5 to 20% by mass, still more preferably 2 to 10% by mass.

The suspending agent may be added in any stage during the step (a).

It is preferable that in the step (a), a solution containing the transition metal compound (1) and the suspending agent is obtained, and then this solution and the nitrogen-containing organic compound (2) are mixed to give a heat-treated product precursor solution, namely, a catalyst carrier precursor solution. When the first transition metal compound and the second transition metal compound are used as the transition metal compounds (1), it is preferable that in the step (a), a solution containing the first transition metal compound and the suspending agent is obtained, and then this solution, the nitrogen-containing organic compound (2) and the second transition metal compound are mixed to give a heat-treated product precursor solution, namely, a catalyst carrier precursor solution. By carrying out the step (a) in this manner, formation of a precipitate can be surely inhibited.

Step (b)

In the step (b), the solvent is removed from the heat-treated product precursor solution obtained in the step (a), namely, a catalyst carrier precursor solution.

Removal of the solvent may be carried out in the atmosphere, or may be carried out in an atmosphere of an inert gas (e.g., nitrogen, argon, helium). As the inert gas, nitrogen or argon is preferable, and nitrogen is more preferable, from the viewpoint of cost.

The temperature for the removal of the solvent may be ordinary temperature when the vapor pressure of the solvent is high, but from the viewpoint of mass productivity of the heat-treated product capable of functioning as a catalyst carrier, the temperature is preferably not lower than 30° C., more preferably not lower than 40° C., still more preferably not lower than 50° C. From the viewpoint that the heat-treated product precursor, which is contained in the solution obtained in the step (a) and presumed to be a metal complex such as a chelate, namely, a catalyst carrier precursor, is not decomposed, the temperature is preferably not higher than 250° C., more preferably not higher than 150° C., still more preferably not higher than 110° C.

When the vapor pressure of the solvent is high, removal of the solvent may be carried out in the atmosphere, but in order to remove the solvent in a shorter period of time, removal of the solvent may be carried out under reduced pressure (e.g., 0.1 Pa to 0.1 MPa). For removal of the solvent under reduced pressure, for example, an evaporator can be used.

Removal of the solvent may be carried out while allowing the mixture obtained in the step (a) to stand still, but in order to obtain a more uniform solid residue, it is preferable to remove the solvent while rotating the mixture.

When the mass of the container containing the mixture is large, it is preferable to rotate the solution using a stirring bar, a stirring blade, a stirrer or the like.

For carrying out removal of the solvent while controlling the degree of vacuum of the container containing the mixture, drying is carried out in a container capable of being closed, and therefore, it is preferable to remove the solvent while rotating the mixture together with the container, that is, to remove the solvent using, for example, a rotary evaporator.

The composition or the aggregation state of the solid residue obtained in the step (b) is sometimes non-uniform depending upon the method for removing the solvent or the property of the transition metal compound (1) or the nitrogen-containing organic compound (2). In such a case, a more uniform and finer powder obtained by mixing and crushing the solid residue is used in the later-described step (c), whereby a heat-treated product of more uniform particle diameters, namely, a catalyst carrier of more uniform particle diameters, can be obtained.

For mixing and crushing the solid residue, for example, a roll rolling mill, a ball mill, a small-diameter ball mill (bead mill), a medium stirring mill, an airflow pulverizer, a mortar, an automatic kneading mortar, a tank crusher or a jet mill can be used. When the amount of the solid residue is small, a mortar, an automatic kneading mortar or a batch type ball mill is preferably used, and when the amount of the solid residue is large and continuous mixing and crushing are carried out, a jet mill is preferably used.

Step (c)

In the step (c), the solid residue obtained in the step (b) is heat-treated to give a heat-treated product. That is to say, in the production process for a catalyst carrier that is used for the fuel cell of the present invention, a catalyst carrier is obtained in the form of this heat-treated product by this step (c).

The temperature of this heat treatment is 500 to 1100° C., preferably 600 to 1050° C., more preferably 700 to 950° C.

If the temperature of the heat treatment is higher than the upper limit of the above range, sintering of particles of the resulting heat-treated product and grain growth take place, and as a result, the specific surface area of the heat-treated product is decreased. Therefore, when the catalyst metal is supported on this particle, processability to give a catalyst layer by a coating method is sometimes deteriorated, or when viewed from another angle, processability of a composite catalyst containing these particles and the catalyst metal into a catalyst layer by a coating method is sometimes deteriorated. On the other hand, if the temperature of the heat treatment is lower than the lower limit of the above range, the activity of the catalyst metal supported may not be sufficiently enhanced, or when viewed from another angle, a composite catalyst having a high activity may not be obtained.

Examples of the heat treatment methods include stationary method, stirring method, dropping method and powder capturing method.

The stationary method is a method in which the solid residue obtained in the step (b) is placed in a stationary type electric furnace or the like and it is heated. In the heating, the solid residue weighed out may be placed in a ceramic container such as an alumina boat or a quartz boat. The stationary method is preferable from the viewpoint that a large amount of the solid residue can be heated.

The stirring method is a method in which the solid residue is placed in an electric furnace such as a rotary kiln and it is heated while stirring. The stirring method is preferable from the viewpoints that a large amount of the solid residue can be heated and aggregation and growth of particles of the resulting heat-treated product can be inhibited. Further, from the viewpoint that a heat-treated product capable of functioning as a catalyst carrier can be continuously produced by giving inclination to the heating furnace, the stirring method is preferable.

The dropping method is a method in which while passing an atmosphere gas into an induction furnace, the furnace is heated up to a predetermined heating temperature, then thermal equilibrium is maintained at the temperature, thereafter the solid residue is dropped in a crucible that is a heating zone of the furnace, and it is heated. The dropping method is preferable from the viewpoint that aggregation and growth of particles of the resulting heat-treated product can be reduced to a minimum.

The powder capturing method is a method in which a mist of the solid residue is made to float in an inert gas atmosphere containing a slight amount of oxygen gas, and the mist is captured in a vertical tubular furnace maintained at a predetermined temperature and heated.

When the heat treatment is carried out by the stationary method, the heating rate is not specifically restricted, but it is preferably about 1° C./min to 100° C./min, more preferably 5° C./min to 50° C./min. The heating time is preferably 0.1 to 10 hours, more preferably 0.5 hour to 5 hours, still more preferably 0.5 to 3 hours. When the heating is carried out using a tubular furnace in the stationary method, the time for heating the heat-treated product particles is 0.1 to 10 hours, preferably 0.5 hour to 5 hours. When the heating time is in the above range, uniform heat-treated product particles tend to be formed.

In the case of the stirring method, the time for heating the solid residue is usually 10 minutes to 5 hours, preferably 30 minutes to 2 hours. When the heating is continuously carried out by, for example, giving inclination to the furnace in this method, an average residence time calculated from a steady flow rate of a sample in the furnace is regarded as the heating time.

In the case of the dropping method, the time for heating the solid residue is usually 0.5 to 10 minutes, preferably 0.5 to 3 minutes. When the heating time is in the above range, a uniform heat-treated product tends to be formed.

In the case of the powder capturing method, the time for heating the solid residue is usually 0.2 second to 1 minute, preferably 0.2 to 10 seconds. When the heating time is in the above range, a uniform heat-treated product tends to be formed.

When the heat treatment is carried out by the stationary method, a heating furnace using LNG (liquefied natural gas), LPG (liquefied petroleum gas), gas oil, heavy oil, electricity or the like as a heat source may be used as a heat treatment device. In this case, the device is preferably not such a device that a flame of a fuel is present inside the furnace, that is, heating is carried out inside the furnace, but such a device that heating is carried out outside the furnace, because an atmosphere in the heat treatment of the solid residue is important in the present invention.

When such a heating furnace that the amount of the solid residue is not less than 50 kg per batch is used, the heating furnace is preferably one using LNG or LPG as a heat source from the viewpoint of cost.

In the case where a heat-treated product that realizes a composite catalyst having a particularly high catalytic activity, namely, a catalyst carrier that particularly enhances an activity of the catalyst metal supported is intended to be obtained, it is desirable to use an electric furnace using electricity as a heat source, which is capable of strict temperature control.

As the furnaces, there can be mentioned those of various shapes, such as tubular furnace, upper lid type furnace, tunnel furnace, box furnace, sample table elevating type furnace (elevator type), bogie hearth furnace, etc. Of these, a tubular furnace, an upper lid type furnace, a box furnace and a sample table elevating type furnace, which are capable of strictly controlling an atmosphere, are preferable, and a tubular furnace and a box furnace are more preferable.

Also in the case where the stirring method is adopted, the aforesaid heat sources can be used. However, especially when inclination is given to a rotary kiln to continuously heat-treat the solid residue in the stirring method, the scale of the equipment is large and the energy consumption tends to be increased, so that it is preferable to utilize a heat source derived from a fuel, such as LPG.

As an atmosphere for carrying out the heat treatment, an atmosphere containing an inert gas as its main component is preferable from the viewpoint that the activity of the catalyst metal supported is enhanced, or when viewed from another angle, from the viewpoint that the activity of a composite catalyst containing the resulting heat-treated product and the catalyst metal is enhanced. Of inert gases, nitrogen, argon and helium are preferable, and nitrogen and argon are more preferable, from the viewpoint that they are relatively inexpensive and easily obtainable. These inert gases may be used singly, or may be used as a mixture of two or more kinds. Although these gases are gases generally accepted as inert, there is a possibility that these inert gases, namely, nitrogen, argon, helium, etc. react with the solid residue in the heat treatment of the step (c).

When a reactive gas is present in an atmosphere for the heat treatment, performance of the catalyst metal supported on the resulting catalyst carrier is sometimes more enhanced, in other words, a composite catalyst containing the resulting heat-treated product and the catalyst metal sometimes exhibits higher catalytic performance. For example, if the heat treatment is carried out in an atmosphere of a mixed gas containing nitrogen gas, argon gas, a mixed gas of nitrogen gas and argon gas or a mixed gas of one or more gases selected from nitrogen gas and argon gas, and one or more gases selected from hydrogen gas, ammonia gas and oxygen gas, an electrode catalyst, which exhibits high catalytic performance when the catalyst metal is supported on the resulting catalyst carrier, is sometimes obtained. When viewed from another angle, if the heat treatment is carried out in such an atmosphere, a composite catalyst containing the resulting heat-treated product sometimes has high catalytic performance.

When hydrogen gas is contained in an atmosphere for the heat treatment, the concentration of hydrogen gas is, for example, not more than 100% by volume, preferably 0.01 to 10% by volume, more preferably 1 to 5% by volume.

When oxygen gas is contained in an atmosphere for the heat treatment, the concentration of oxygen gas is, for example, 0.01 to 10% by volume, preferably 0.01 to 5% by volume.

When none of the transition metal compound (1), the nitrogen-containing organic compound (2) and the solvent have an oxygen atom, the heat treatment is preferably carried out in an atmosphere containing oxygen gas.

After the heat treatment, the heat-treated product may be crushed. If crushing is carried out, processability in the production of an electrode using a supported catalyst, which is obtained by using the resulting heat-treated product as a catalyst carrier and allowing the catalyst carrier to support the catalyst metal, that is, a composite catalyst containing the resulting heat-treated product and the catalyst metal, and characteristics of the resulting electrode can be sometimes improved. For the crushing, for example, a roll rolling mill, a ball mill, a small-diameter ball mill (bead mill), a medium stirring mill, an airflow pulverizer, a mortar, an automatic kneading mortar, a tank crusher or a jet mill can be used. When the amount of the electrode catalyst is small, a mortar, an automatic kneading mortar or a batch type ball mill is preferable, and when a large amount of the heat-treated product is continuously treated, a jet mill or a continuous type ball mill is preferable, and of the continuous type ball mills, a bead mill is more preferable.

Heat-Treated Product

The heat-treated product not only can become a component to constitute a composite catalyst used in the present invention together with the catalyst metal but also has a function to more enhance the activity of the composite catalyst by virtue of a synergistic effect with the catalyst metal. In the present invention, this heat-treated product can function as a catalyst carrier.

When the ratio of the number of atoms among the transition metal element (with the proviso that the transition metal element M1 and the transition metal element M2 are not distinguished from each other), carbon, nitrogen and oxygen that constitute the heat-treated product is represented by transition metal element:carbon:nitrogen:oxygen=1:x:y:z, x, y and z are preferably numbers of 0<x≦7, 0<y≦2 and 0<z≦3.

Because the activity of the catalyst metal is enhanced when it is supported, in other words, because the activity of the composite catalyst is enhanced, the range of x is more preferably 0.15≦x≦5.0, still more preferably 0.2≦x≦4.0, particularly preferably 1.0≦x≦3.0; the range of y is more preferably 0.01≦y≦1.5, still more preferably 0.02≦y≦0.5, particularly preferably 0.03≦y≦0.4; and the range of z is more preferably 0.6≦z≦2.6, still more preferably 0.9≦z≦2.0, particularly preferably 1.3≦z≦1.9.

In the present invention, the heat-treated product contains, as the transition metal elements, the transition metal element M1 and at least one transition metal element M2 selected from iron, nickel, chromium, cobalt, vanadium and manganese, and when the ratio of the number of atoms among the transition metal element M1, the transition metal element M2, carbon, nitrogen and oxygen is represented by transition metal element M1:transition metal element M2:carbon:nitrogen:oxygen=(1-a):a:x:y:z, a, x, y and z are preferably numbers of 0<a≦0.5, 0<x≦7, 0<y≦2 and 0<z≦3. If the heat-treated product containing M2 in this manner is used as the catalyst carrier, the activity of the catalyst metal supported can be more enhanced. In other words, the composite catalyst containing the heat-treated product containing M2 in this manner exhibits higher performance.

Because the activity of the catalyst metal supported is enhanced, in other words, because the activity of the composite catalyst is enhanced, preferred ranges of x, y and z are as described above, and the range of a is more preferably 0.01≦a≦0.5, still more preferably 0.02≦a≦0.4, particularly preferably 0.05≦a≦0.3. When the element ratios are in the above ranges, the oxygen reduction potential tends to be increased, so that such ranges are preferable.

The values of the above a, x, y and z are values measured by the method adopted in the later-described Examples.

The effects expected by virtue of presence of the transition metal element M2 (at least one metal element selected from iron, nickel, chromium, cobalt, vanadium and manganese) are presumed as follows.

(1) The transition metal element M2 or a compound containing the transition metal element M2 acts as a catalyst for forming a bond between the transition metal element M1 atom and a nitrogen atom in the synthesis of a heat-treated product.

(2) Even in the case where an electrode catalyst is used in such a highly potential and highly oxidizing atmosphere as to cause elution of the transition metal element M1, further elution of the transition metal element M1 can be prevented by passivating the transition metal element M2.

(3) Sintering of the heat-treated product is prevented in the heat treatment of the step (c).

(4) By the presence of the transition metal element M1 and the transition metal element M2, deviation of charges occurs at the site where these metal elements are adjacent to each other, and adsorption or reaction of a substrate or desorption of a product takes place though such a phenomenon is not brought about by a heat-treated product having only the transition metal element M1 as a metal element.

The heat-treated product for use in the present invention preferably has atoms of a transition metal element, carbon, nitrogen and oxygen and has a single crystal structure of an oxide, a carbide or a nitride or plural crystal structures of them. Judging from results of crystal structure analysis of the heat-treated product by the powder X-ray diffractometry and results of elemental analysis, the heat-treated product is presumed to have a structure wherein the site of an oxygen atom of an oxide structure is replaced with a carbon atom or a nitrogen atom while having an oxide structure of the transition metal element, or to have a structure wherein the site of a carbon atom or a nitrogen atom is replaced with an oxygen atom while having a structure of a carbide, a nitride or a carbonitride of the transition metal element, or to be a mixture containing these structures.

BET Specific Surface Area of Heat-Treated Product

The heat-treated product obtained by the above step has a large specific surface area, and its specific surface area as measured by a BET method is preferably 30 to 400 m²/g, more preferably 50 to 350 m²/g, still more preferably 100 to 300 m²/g.

Step (d)

In the step (d), a composite catalyst containing the heat-treated product and the catalyst metal is obtained. When the step (d) is seen based on the production process for a catalyst carrier in the present invention, this step (d) can be regarded as a step of allowing the catalyst carrier obtained by the production process for a catalyst carrier to support the catalyst metal thereon to give a supported catalyst. In any case, the composite catalyst obtained in this step (d) can be obtained in the form of composite particles, and in the fuel cell of the present invention, it can be preferably used as an oxygen reduction catalyst.

Here, the catalyst metal to constitute the composite catalyst together with the heat-treated product, or when viewed from another angle, the catalyst metal supported on the catalyst carrier, is not specifically restricted provided that it is a catalyst metal capable of functioning as an electrode catalyst for a fuel cell. However, palladium or a palladium alloy is used as the catalyst metal because when the fuel cell of the present invention is used as a direct methanol fuel cell, lowering of cathode performance due to methanol crossover can be preferably inhibited. This catalyst metal may be an alloy of the transition metal element M1 and the transition metal element M2. In the case where the composite catalyst or the supported catalyst obtained by the present invention is used particularly as an oxygen reduction catalyst in a direct methanol fuel cell, lowering of cathode performance due to methanol crossover can be preferably inhibited by using palladium or a palladium alloy as the catalyst metal.

The method for obtaining a composite catalyst containing the heat-treated product and the catalyst metal, or when viewed from another angle, the method for allowing the catalyst carrier to support the catalyst metal thereon, is not specifically restricted provided that such a composite catalyst or the like is obtainable in a practically usable manner. However, a method for obtaining the composite catalyst of the present invention using a precursor of the catalyst metal, or when viewed from another angle, a method of allowing the catalyst carrier to support the catalyst metal thereon using a precursor of the catalyst metal, is preferable. Here, the precursor of the catalyst metal is a substance capable of becoming the catalyst metal by carrying out a given treatment.

The method for obtaining the composite catalyst of the present invention using the precursor of the catalyst metal, or when viewed from another angle, the method of allowing the catalyst carrier to support the precursor of the catalyst metal thereon, should not be specifically restricted, and a method can be used to which hitherto publicly known technique has been applied.

### Examples of Such Methods Include

(1) a method including a stage in which the heat-treated product is dispersed in a catalyst metal precursor solution and evaporated to dryness and a stage in which heat treatment is carried out thereafter,

(2) a method including a stage in which the heat-treated product is dispersed in a catalyst metal precursor colloidal solution to allow the catalyst metal precursor colloid to be adsorbed by the heat-treated product, whereby the catalyst metal is supported on the heat-treated product, and

(3) a method including a stage in which pH of a mixed solution of a solution containing one or more metal compounds that are raw materials of a heat-treated product precursor and a catalyst precursor colloidal solution is controlled to give a precursor of the heat-treated product and at the same time the catalyst precursor colloid is allowed to be adsorbed by the precursor and a stage in which it is heat-treated.

However, the method for obtaining the composite catalyst is in no way limited to those methods.

Here, the catalyst metal precursor solution has only to be one from which such a catalyst metal as previously described can be formed (remains after heat treatment) through the above stages. The content of the catalyst metal precursor in the catalyst metal precursor solution should not be specifically restricted, and it has only to be not more than the saturated concentration. In the case of a low concentration, however, it is necessary to repeat the above stage until the amount supported or the amount introduced is adjusted to a given amount, and therefore, a necessary concentration is appropriately determined. The content of the catalyst metal precursor in the catalyst metal precursor solution is about 0.01 to 50% by mass, but the content is not limited thereto.

In a particularly preferred embodiment, the step (d) includes the following steps (d1) to (d5):

(d1) a step including dispersing the heat-treated product in a solution of 40 to 80° C. and adding a water-soluble catalyst metal compound to impregnate the heat-treated product with the water-soluble catalyst metal compound,

(d2) a step of adding an aqueous basic compound solution to the solution obtained in the step (d1) to convert the water-soluble catalyst metal compound to a water-insoluble catalyst metal compound,

(d3) a step of adding a reducing agent to the solution obtained in the step (d2) to convert the water-insoluble catalyst metal compound to a catalyst metal,

(d4) a step including filtering the solution obtained in the step (d3), washing the residue and drying it, and

(d5) a step of heat-treating the powder obtained in the step (d4) at a temperature of not lower than 150° C. but not higher than 1000° C.

Examples of the water-soluble catalyst metal compounds include oxides, hydroxides, chlorides, sulfides, bromides, nitrates, acetates, carbonates, sulfates and various complex salts of catalyst metals. Specific examples thereof include palladium chloride and tetraamminepalladium(II) chloride, but the water-soluble catalyst metal compounds should not be limited thereto. These water-soluble catalyst metal compounds may be used singly, or may be used in combination of two or more kinds.

In the step (d1), the solvent to constitute the solution is not specifically restricted as long as it functions as a medium for allowing the heat-treated product to support the catalyst metal thereon through dispersing or as a medium for impregnating the heat-treated product with the catalyst metal through dispersing, but in usual, water and alcohols are preferably used. As the alcohols, ethanol, methanol, butanol, propanol and ethoxyethanol are preferable, and ethanol and methanol are more preferable. These may be used singly, or may be used in combination of two or more kinds. The content of the water-soluble catalyst metal compound in the solution is not specifically restricted, and it has only to be not more than the saturated concentration. The content of the water-soluble catalyst metal compound is specifically about 0.01 to 50% by mass, but the content is not limited thereto. Although the time for impregnation of the heat-treated product with the water-soluble catalyst metal compound is not specifically restricted, it is preferably 10 minutes to 12 hours, more preferably 30 minutes to 6 hours, still more preferably 1 to 3 hours.

In the step (d2), the basic compound to constitute the aqueous basic compound solution is not specifically restricted provided that it can convert the water-soluble catalyst metal compound to a water-insoluble catalyst metal compound. Examples of preferred basic compounds include sodium hydroxide, sodium carbonate, potassium hydroxide, potassium carbonate, calcium hydroxide and calcium carbonate.

The reducing agent used in the step (d3) is not specifically restricted provided that it can convert the water-insoluble catalyst metal compound to a catalyst metal by reducing the water-insoluble catalyst metal compound. Examples of preferred reducing agents include an aqueous formaldehyde solution, sodium borohydride, hydrazine, ethylene glycol, ethylene and propylene. In the step (d3), after addition of the reducing agent, stirring is carried out at 40 to 80° C. to reduce the water-insoluble catalyst metal compound to a catalyst metal. Although the stirring time is not specifically restricted, it is preferably 10 minutes to 6 hours, more preferably 30 minutes to 3 hours, still more preferably 1 to 2 hours.

In the step (d4), the conditions of the filtration are not specifically restricted, but the filtration is preferably carried out until pH of the solution after washing becomes not more than 8. The drying is carried out at 40 to 80° C. in air or an inert atmosphere.

The heat treatment in the step (d5) can be carried out in a gas atmosphere containing, for example, nitrogen and/or argon. The heat treatment can be also carried out in an atmosphere of a gas obtained by mixing hydrogen with the above gas so that the amount of hydrogen might be more than 0% by volume but not more than 5% by volume based on the total gas. The heat treatment temperature is preferably in the range of 300 to 1100° C., more preferably 500 to 1000° C., still more preferably 700 to 900° C.

An example of a more specific process in which platinum is used as the catalyst metal is, for example, the following process.

To the heat-treated product, distilled water is added, and they are shaken by an ultrasonic washing machine for 30 minutes. While stirring this suspension, the liquid temperature is maintained at 80° C. by a hot plate, and sodium carbonate is added.

An aqueous chloroplatinic acid solution prepared in advance is added to the above suspension over a period of 30 minutes. Thereafter, the suspension is stirred for 2 hours at a liquid temperature of 80° C.

Next, an aqueous 37% formaldehyde solution is slowly added to the above suspension. Thereafter, the suspension is stirred for 1 hour at a liquid temperature of 80° C.

After the reaction is completed, the suspension is cooled and filtered.

The resulting powder is heat-treated at 800° C. for 1 hour in a 4 vol % hydrogen/nitrogen atmosphere, whereby a platinum-containing composite catalyst that is a composite catalyst of the present invention is obtained. On the basis of the production process for a catalyst carrier in the present invention, this platinum-containing composite catalyst can be regarded as a platinum-supported catalyst that is a supported catalyst of the present invention.

After the step (d) is carried out, a composite catalyst used in an electrode for a fuel cell is obtained. In a preferred embodiment of the present invention, the proportion occupied by the catalyst metal in the total mass of the composite catalyst is 0.01 to 50% by mass.

A process for obtaining a composite catalyst used for a direct methanol fuel cell, in which palladium is used as a catalyst metal, is, for example, the following process.

In the first place, distilled water is added to the heat-treated product, they are shaken by an ultrasonic washing machine for 30 minutes, and while stirring the resulting suspension, the liquid temperature is maintained at 80° C. by a hot plate.

Next, an aqueous palladium chloride solution prepared in advance is added to the above suspension over a period of 30 minutes, and then the suspension is stirred for 2 hours at a liquid temperature of 80° C. Thereafter, 1M sodium hydroxide is slowly added until pH of the suspension becomes 11, then 1M sodium borohydride is slowly added to the suspension until palladium is sufficiently reduced, and thereafter, the suspension is stirred for 1 hour at a liquid temperature of 80° C. After the reaction is completed, the suspension is cooled and filtered.

The resulting powder is heat-treated at 300° C. for 1 hour in a 4 vol % hydrogen/nitrogen atmosphere, whereby a palladium-containing composite catalyst that is a composite catalyst of the present invention is obtained.

After the step (d) is carried out, a composite catalyst used in an electrode for a fuel cell is obtained. In a preferred embodiment of the present invention, the proportion occupied by the catalyst metal in the total mass of the composite catalyst is 0.01 to 50% by mass.

Composite Catalyst

The composite catalyst produced in the form of composite particles by the above-mentioned production process can be favorably used as an oxygen reduction catalyst for constituting the fuel cell of the present invention. On the basis of the catalyst carrier obtained by the production process for a catalyst carrier, this composite catalyst can be regarded as a supported catalyst.

According to the above production process, a composite catalyst having a large specific surface area is produced, and the specific surface area of the composite catalyst used in the present invention, as measured by a BET method, is preferably 30 to 350 m²/g, more preferably 50 to 300 m²/g, still more preferably 100 to 300 m²/g.

The oxygen reduction onset potential of the composite catalyst, as measured in accordance with the measuring method (A) described in the following Examples, is preferably not less than 0.9 V (vs. RHE), more preferably not less than 0.95 V (vs. RHE), still more preferably not less than 1.0 V (vs. RHE), based on a reversible hydrogen electrode.

The effects expected by virtue of presence of the catalyst metal (platinum, gold, silver, copper, palladium, rhodium, ruthenium, iridium, osmium and rhenium, and alloys composed of two or more kinds of them), the transition metal element M1 (at least one metal element selected from the group consisting of titanium, zirconium, hafnium and tantalum) and the transition metal element M2 (at least one metal element selected from iron, nickel, chromium, cobalt, vanadium and manganese) are presumed to be as follows.

(1) The heat-treated product to constitute the composite catalyst acts as such a co-catalyst as to bring about adsorption or reaction of a substrate or desorption of a product, whereby catalytic action of the catalyst metal is enhanced.

(2) At the site where different metals of the transition metal element M1 and the transition metal element M2 are adjacent to each other, deviation of charges occurs, and adsorption or reaction of a substrate or desorption of a product, which is not brought about by them independently, takes place.

<Solid Polymer Electrolyte>

As the solid polymer electrolytes contained in the anode catalyst layer 12 and the cathode catalyst layer 14 and the solid polymer electrolyte used in the solid polymer electrolyte membrane 13, acidic hydrogen ion conductive materials are preferable because by the use of them, a stable fuel cell can be realized without being influenced by carbonic acid gas in the atmosphere. As such materials,

sulfonated fluoropolymers, typical examples of which include polyperfluorostyrenesulfonic acid and perfluorocarbon-based sulfonic acid;

materials obtained by sulfonating hydrocarbon-based polymers, such as polystyrenesulfonic acids, sulfonated polyethersulfones and sulfonated polyether ether ketones; or

materials obtained by alkylsulfonating hydrocarbon-based polymers

can be used. In the present specification, the acidic hydrogen ion conductive materials such as the above materials are also sometimes referred to as “proton conductive materials”. The solid polymer electrolyte membrane 13 is also sometimes referred to as an “electrolyte membrane” simply.

The solid polymer electrolytes used in the anode catalyst layer 12, the cathode catalyst layer 14 and the solid polymer electrolyte membrane 13 may be the same materials as one another, or may be different materials from one another.

<Electron Conductive Substance>

In the present invention, the cathode catalyst layer 14 preferably further contains an electron conductive substance. When the cathode catalyst layer 14 containing the composite catalyst further contains an electron conductive substance, reduction current can be more increased. The present inventors assume that the electron conductive substance allows the composite catalyst to produce an electrical contact for inducing electrochemical reaction, and therefore, reduction current is increased.

In the present invention, this electron conductive substance can be usually used for supporting the composite catalyst. The composite catalyst has conductivity of a certain level, but in order to give more electrons to this composite catalyst, or in order that the reaction substrate may receive many electrons from this composite catalyst, the electron conductive substance may be mixed with the composite catalyst. The electron conductive substance may be mixed with the composite catalyst produced through the step (a) to the step (d), or may be mixed in any step of the step (a) to the step (d).

An electron conductive material used as the electron conductive substance used in the present invention is not specifically restricted, but examples thereof include carbon, a conductive polymer, conductive ceramic, a metal and a conductive inorganic oxide such as tungsten oxide or iridium oxide. These electron conductive materials may be used singly, or may be used in combination or two or more kinds. In particular, conductive particles made of carbon are preferable because they have large specific surface area, particles of small particle diameters are inexpensively and easily obtainable, and they are excellent in chemical resistance and resistance to high potential. When the conductive particles made of carbon are used, carbon alone or a mixture of carbon and other conductive particles is preferable. That is to say, the cathode catalyst layer 14 preferably contains the composite catalyst and carbon (particularly carbon particles).

Examples of carbons include carbon black, graphite, black lead, activated carbon, carbon nanotube, carbon nanofiber, carbon nanohorn, fullerene, porous carbon and graphene.

When the electron conductive substance is made of carbon, the mass ratio between the composite catalyst and the electron conductive substance (catalyst:electron conductive substance) is preferably 1:1 to 1000:1, more preferably 2:1 to 100:1, still more preferably 4:1 to 10:1.

The conductive polymer is not specifically restricted, but examples thereof include polyacetylene, poly-p-phenylene, polyaniline, polyalkylaniline, polypyrrole, polythiophene, polyindole, poly-1,5-diaminoanthraquinone, polyaminodiphenyl, poly(o-phenylenediamine), poly(quinolinium) salt, polypyridine, polyquinoxaline, polyphenylquinoxaline, and their derivatives. Of these, polypyrrole, polyaniline and polythiophene are preferable, and polypyrrole is more preferable. In these conductive polymers, a dopant for obtaining high conductivity may be contained.

<Solvent>

Although the solvent for use in the present invention is not specifically restricted, a volatile organic solvent, water or the like can be mentioned.

Specific examples of the solvents include alcohol solvents, ether solvents, aromatic solvents, aprotic polar solvents and water. Of these, water, acetonitrile and alcohols of 1 to 4 carbon atoms are preferable, and specifically, methanol, ethanol, 1-propanol, 2-propanol, 1-butanol, 2-butanol, isobutanol and t-butanol are preferable. In particular, water, acetonitrile, 1-propanol and 2-propanol are preferable. These solvents may be used singly, or may be used in combination of two or more kind.

<Preparation Process for Catalyst Ink>

The anode catalyst layer 12 and the cathode catalyst layer 14 to constitute the fuel cell of the present invention can be each usually formed as a coating film from a catalyst ink containing its constituent catalyst. In the catalyst ink for anode to give the anode catalyst layer 12, one or more selected from platinum, gold, palladium, iridium, rhodium, ruthenium, iron, cobalt, nickel and the like can be used as the catalysts, as previously described. In the catalyst ink for cathode to give the cathode catalyst layer 14, the composite catalyst obtained in the form of the composite particles can be used as the catalyst.

The catalyst ink for use in the present invention is prepared by mixing the catalyst for constituting the desired catalyst layer, the electron conductive substance, the solid polymer electrolyte and the solvent. The order of mixing the catalyst, the electron conductive substance, the solid polymer electrolyte and the solvent is not specifically restricted. For example, the catalyst, the electron conductive substance, the solid polymer electrolyte and the solvent are mixed in order or at the same time to disperse the catalyst, etc. in the solvent, whereby the ink can be prepared. It is also possible that a solution in which the solid polymer electrolyte is premixed with water and/or an alcohol solvent such as methanol, ethanol or propanol is prepared, and then the premixed solution is mixed with the catalyst, the electron conductive substance and the solvent.

The mixing time can be properly determined according to a mixing means, dispersibility of the catalyst or the like, volatility of the solvent, etc.

As the mixing means, a stirring device such as a homogenizer may be used, or a ball mill, a bead mill, a jet mill, an ultrasonic dispersing device, a kneading defoaming device or the like may be used, and these means may be used in combination. Of these, a mixing means, such as an ultrasonic dispersing device, homogenizer, ball mill or kneading defoaming device, is preferable. If necessary, mixing may be carried out while using a mechanism, a device or the like for maintaining the ink temperature in a given range.

<<Anode Diffusion Layer, Cathode Diffusion Layer>>

The anode diffusion layer 11 used in the fuel cell of the present invention is not specifically restricted provided that it is a layer of a porous material having electron conductivity, but carbon paper or carbon cloth is preferably used. The anode diffusion layer 11 may have a microporous layer containing carbon black and a binder on its surface that is in contact with the anode catalyst layer 12. When the microporous layer is present, contact resistance between the anode diffusion layer 11 and the anode catalyst layer 12 can be reduced. However, the microporous layer sometimes inhibits transparency of a fuel, and therefore, use of the microporous layer is determined according to the operating conditions of the fuel cell system. The binder contained in the micoporous layer may be a water-repellent resin or may be a hydrophilic resin.

The cathode diffusion layer 15 used in the fuel cell of the present invention contains an oxidation catalyst and a water-repellent resin. In the present specification, the oxidation catalyst is a catalyst that accelerates a reaction for oxidizing the “reaction intermediate” to water and/or carbon dioxide.

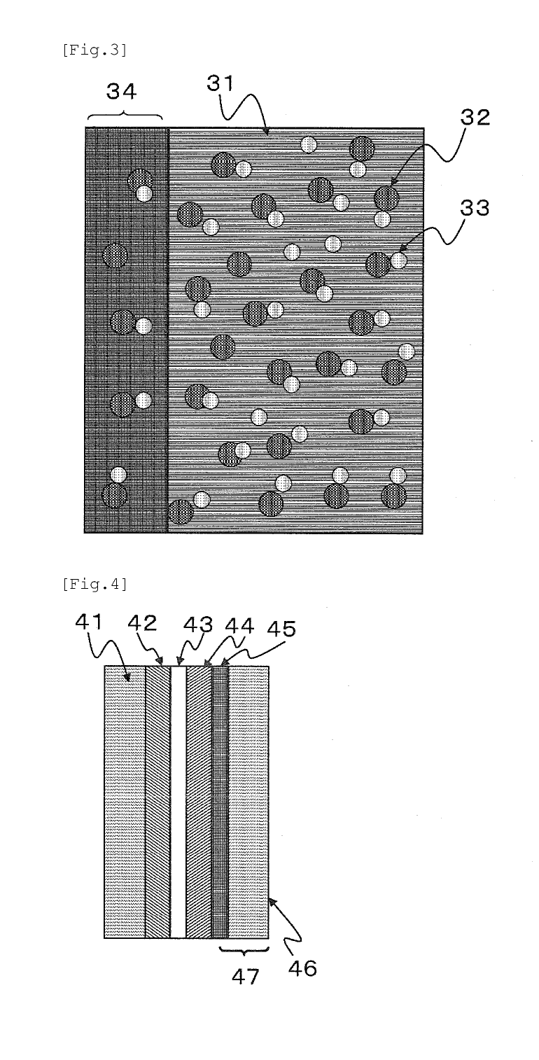

An enlarged sectional schematic view of the cathode diffusion layer 15 is shown in FIG. 2. As shown in FIG. 2, a porous material having electron conductivity is used as a base 21 in the cathode diffusion layer 15. The material to form the base 21 is not specifically restricted, but carbon paper or carbon cloth is preferably used. In the base 21, an oxidation catalyst (also referred to as a “reaction intermediate oxidation catalyst” hereinafter in the present specification) 22 for oxidizing the “reaction intermediate” and a water-repellent resin 23 are contained. In the case of DMFC, oxidation of the reaction intermediate such as formic acid, methyl formate or formaldehyde is carried out by the reaction intermediate oxidation catalyst 22.

Oxygen is required for the oxidation of the reaction intermediate discharged from the cathode catalyst layer 14, and therefore, if the reaction intermediate oxidation catalyst 22 is soaked in water, supply of oxygen is inhibited, and efficiency of the oxidation reaction is sometimes markedly lowered. By the use of the water-repellent resin 23 together with the reaction intermediate oxidation catalyst 22, lowering of oxidation reaction efficiency caused by the soaking of the reaction intermediate oxidation catalyst 22 in water that is produced by the power generation reaction or water that has permeated through the anode catalyst layer 12 can be prevented.

As the reaction intermediate oxidation catalyst 22, at least one selected from platinum, palladium, copper, silver, tungsten, molybdenum, iron, nickel, cobalt, manganese, zinc and vanadium is preferably used. Here, the reaction intermediate oxidation catalyst 22 may be used alone as such, or may be used in a supported state on a carrier such as carbon black. It is preferable to use the reaction intermediate oxidation catalyst 22 in the form of fine particles having a diameter of not more than 1 μm because the specific surface area can be increased.

The water-repellent resin 23 is a resin that does not have many polar groups such as sulfonic acid group and carboxylic acid group, and is preferably at least one kind selected from polytetrafluoroethylene, polychlorotrifluoroethylene, poly(vinylidene fluoride), poly(vinyl fluoride), a perfluoroalkoxyfluorine resin, a tetrafluoroethylene/hexafluoropropylene copolymer, an ethylene/tetrafluoroethylene copolymer, an ethylene/chlorotrifluoroethylene copolymer, polyethylene, polyolefin, polypropylene, polyaniline, polythiopheneandpolyester.

Oxygen required for the oxidation of the reaction intermediate is also used as oxygen that is supplied to the cathode catalyst layer 14 as an oxidizing agent necessary for the power generation reaction.

Although the thickness of the cathode diffusion layer 15 is not specifically restricted, it is preferably 10 to 1000 μm. If the cathode diffusion layer 15 is too thin, the time for passing of the reaction intermediate through the cathode diffusion layer 15 is shortened, and the proportion of the reaction intermediate oxidized by the reaction intermediate oxidation catalyst 22 is decreased. If the layer is too thick, oxygen permeability is deteriorated to lower the output of the fuel cell system. Although the amount of the reaction intermediate oxidation catalyst contained in the cathode diffusion layer in the present invention is not specifically restricted, it is desirably not less than 1×10⁻⁵ mol based on 1 cm³ of the cathode diffusion layer. Although the amount of the water-repellent resin contained in the cathode diffusion layer in the present invention is not specifically restricted, it is desirably not less than 3.4×10⁻⁵ g based on 1 cm³ of the cathode diffusion layer.

In FIG. 3, an enlarged sectional schematic view of another embodiment of the cathode diffusion layer 15 used in the present invention is shown. The cathode diffusion layer 15 has a microporous layer 34 containing carbon black and a binder on its surface that is in contact with the cathode catalyst layer 14. By providing the microporous layer in this manner, contact resistance between the cathode diffusion layer 15 and the cathode catalyst layer 14 can be reduced. However, transparency of oxygen is sometimes inhibited by the microporous layer, and therefore, use of the microporous layer is preferably determined according to the operating conditions of the fuel cell system. The binder contained in the microporous layer is a water-repellent resin, and the same resin as a water-repellent resin 33 contained in a base 31 that is a porous material having electron conductivity is used. Also in the mircoporous layer, a reaction intermediate oxidation catalyst 32 can be introduced. The thickness of the microporous layer is not specifically restricted, but it is preferably about 1/20 to ¼ the thickness of the base 31.

A process for obtaining the cathode diffusion layer 15 containing the reaction intermediate oxidation catalyst and the water-repellent resin is described below.

A powder of the reaction intermediate oxidation catalyst is added to water in which the water-repellent resin has been dispersed with a surface active agent, then they are stirred and mixed, and thereafter the mixture is dropped on carbon paper, followed by drying in the atmosphere. Thereafter, the dried product is calcined in the atmosphere to remove the surface active agent, whereby the cathode diffusion layer 15 can be obtained. The calcining temperature is preferably 300 to 400° C.

In another process, a precursor compound (e.g., chloride, nitiride, ammine complex or the like) of the reaction intermediate oxidation catalyst is added to water in which the water-repellent resin has been dispersed with a surface active agent, to dissolve the precursor compound, and then carbon paper is impregnated with the resulting mixture, followed by drying in the atmosphere. Thereafter, calcining is carried out in the atmosphere to remove the surface active agent. Further, heat treatment is carried out in a hydrogen atmosphere to reduce the precursor compound of the reaction intermediate oxidation catalyst to a metal, whereby the cathode diffusion layer 15 can be obtained. Here, the treatment temperature in the hydrogen atmosphere is preferably 100 to 500° C.

In another process, a precursor (e.g., alkoxide, acetylacetonate complex or the like) of the reaction intermediate oxidation product is dissolved in an alcohol (methanol, ethanol, propanol or the like) in which a water-repellent resin powder has been dispersed, and the resulting mixture is dropped on carbon cloth. Thereafter, drying is carried out in the atmosphere, and then the precursor of the reaction intermediate oxidation catalyst is reduced to a metal in a hydrogen atmosphere, whereby the cathode diffusion layer can be obtained.

In another process, the reaction intermediate oxidation catalyst in the form of fine particles, said oxidation catalyst being supported on carbon black, and a surface active agent powder are dispersed in an alcohol, and then carbon paper is impregnated with the resulting dispersion, followed by drying in the atmosphere, whereby the cathode diffusion layer 15 can be obtained.

In another process, carbon cloth, in which the reaction intermediate oxidation catalyst and the water-repellent resin have been introduced in advance in such a manner as above, is coated with a slurry obtained by mixing the reaction intermediate oxide in the form of fine particles, said oxidation catalyst being supported on carbon black, a water-repellent resin powder and an alcohol, and the slurry is dried in the atmosphere, whereby the cathode diffusion layer 15 having a microporous layer can be obtained. Even if the reaction intermediate oxidation catalyst has become an oxide during storage or in environment of power generation of a fuel cell, an effect of reaction intermediate discharge inhibition can be obtained.

A surface of the cathode diffusion layer 15 obtained as above is coated with the catalyst ink for cathode, and the ink is dried to forma cathode having the cathode catalyst layer 14. On the other hand, a surface of the anode diffusion layer 11 is coated with the catalyst ink for anode, and the ink is dried to form an anode having the anode catalyst layer 12. Between these cathode and anode, the solid polymer electrolyte 13 is interposed, and they are subjected to thermocompression bonding using a hot press, whereby a membrane electrode assembly used in the fuel cell of the present invention is obtained. The membrane electrode assembly can be also obtained by coating one surface of the solid polymer electrolyte membrane 13 with the catalyst ink for cathode, drying the ink to form a cathode catalyst layer 14, coating the other surface with the catalyst ink for anode, drying the ink to form an anode catalyst layer 12, then interposing them between the cathode diffusion layer 15 that is arranged on the side where the cathode catalyst layer 14 is present and the anode diffusion layer 11 that is arranged on the side where the anode catalyst layer 12 is present, and subjecting them to thermocompression bonding using a hot press.

Examples of methods for coating with the catalyst ink include dipping, screen printing, roll coating, spraying, bar coater method and doctor blade method.

Examples of methods for drying the catalyst ink include air drying and heating by a heater. In the case of heating, the drying temperature is preferably 30 to 120° C., more preferably 40 to 110° C., still more preferably 45 to 100° C.

The coating and the drying may be simultaneously carried out. In this case, it is preferable that drying is completed immediately after coating by adjusting the amount of coating and the drying temperature.

The temperature in the hot pressing is properly selected according to the components used in the solid polymer electrolyte membrane 13 and/or the catalyst layers, but it is preferably 100 to 160° C., more preferably 120 to 160° C., still more preferably 120 to 140° C. If the temperature in the hot pressing is lower than the lower limit, bonding is liable to be insufficient, and if the temperature exceeds the upper limit, the components of the solid polymer electrolyte membrane 13 and/or the catalyst layers are liable to be deteriorated.

The pressure in the hot pressing is properly selected according to the components of the solid polymer electrolyte membrane 13 and/or the catalyst layers and the types of the diffusion layers, but it is preferably 1 to 10 MPa, more preferably 1 to 6 MPa, still more preferably 2 to 5 MPa. If the pressure in the hot pressing is lower than the lower limit, bonding is liable to be insufficient, and if the pressure exceeds the upper limit, porosity of the catalyst layers and the diffusion layers is lowered, and the performance is liable to be deteriorated.

The time for the hot pressing is properly selected according to the temperature and the pressure in the hot pressing, but it is preferably 1 to 20 minutes, more preferably 3 to 20 minutes, still more preferably 5 to 20 minutes.

In the membrane electrode assembly used in the fuel cell of the present invention, the cathode diffusion layer is not limited to one having only a layer containing the reaction intermediate oxidation catalyst, and it may further has a layer containing no reaction intermediate oxidation catalyst.

In FIG. 4, a sectional schematic view of another embodiment of the membrane electrode assembly used in the fuel cell of the present invention is shown. Here, as an anode diffusion layer 41, an anode catalyst layer 42, a solid polymer electrolyte membrane 43 and a cathode catalyst layer 44 to constitute the membrane electrode assembly shown in FIG. 4, the same ones as the anode diffusion layer 11, the anode catalyst layer 12, the solid polymer electrolyte membrane 13 and the cathode catalyst layer 14 can be used, respectively.

The cathode diffusion layer 47 has a two-layer structure, and a first layer 45 contains no reaction intermediate oxidation catalyst. However, it may contain a water-repellent resin. On the other hand, a second layer 46 contains the reaction intermediate oxidation catalyst and a water-repellent resin. That is to say, as the second layer 46, the same layer as the cathode diffusion layer 15 can be used, and as the first layer 45, the same layer as the cathode diffusion layer 15 except for containing no reaction intermediate oxidation catalyst can be used.

The membrane electrode assembly described in FIG. 4 can be also formed by the same method as the method for forming the membrane electrode assembly shown in FIG. 1.

In the case where an acidic hydrogen ion conductor is used as the solid polymer electrolyte contained in the cathode catalyst layer 44, copper, silver, iron, nickel, cobalt, manganese, zinc or vanadium, namely, the reaction intermediate oxidation catalyst may be eluted if it is in contact with the cathode catalyst layer. The reaction intermediate oxidation catalyst eluted becomes cation, and ion exchange between the cation and hydrogen ion of an ion-exchange group of the solid polymer electrolyte contained in the cathode occurs to markedly lower hydrogen ionic conductivity, so that the output of the fuel cell is lowered. On that account, the first layer 45 containing no reaction intermediate oxidation catalyst is provided at the position that is in contact with the cathode catalyst layer 44, whereby elution of the reaction intermediate oxidation catalyst can be inhibited, and lowering of the output of the fuel cell can be avoided.

[Fuel Cell]

The fuel cell of the present invention has the above-mentioned membrane electrode assembly.

The electrode reaction of the fuel cell takes place on a so-called three-phase interface (electrolyte-electrode catalyst-reaction gas). Fuel cells are classified into several categories according to a difference of the electrolyte used and the like, and there are molten carbonate fuel cell (MCFC), phosphoric acid fuel cell (PAFC), solid oxide fuel cell (SOFC), polymer electrolyte fuel cell (PEFC), etc. The membrane electrode assembly of the present invention is preferably used in the polymer electrolyte fuel cell, particularly a polymer electrolyte fuel cell using hydrogen or methanol as a fuel, among the above fuel cells.

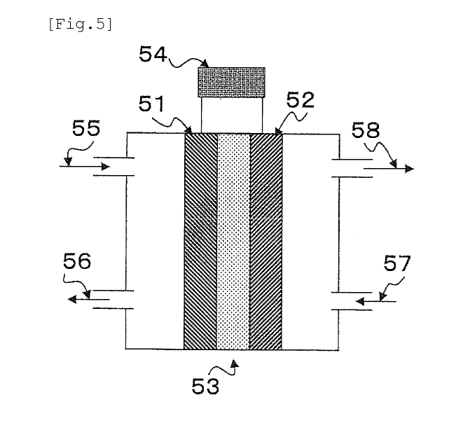

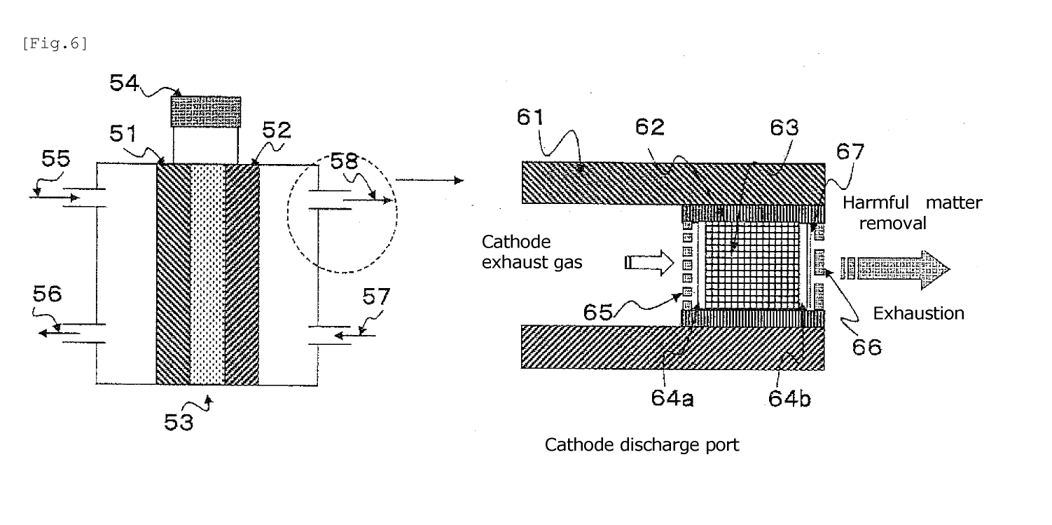

In FIG. 5, an illustrative sectional schematic view of the fuel cell of the present invention is shown. As a membrane electrode assembly 53, such a membrane electrode assembly as illustrated in the aforesaid FIG. 1 or FIG. 4 can be used.

As shown in FIG. 5, an anode collector 51 is superposed on an anode diffusion layer of the membrane electrode assembly 53, a cathode collector 52 is superposed on a cathode diffusion layer, and the anode collector 51 and the cathode collector 52 are connected to an external circuit 54. Here, when the fuel cell of the present invention is used as a direct methanol fuel cell (DMFC), an aqueous methanol solution 55 is supplied and a waste liquid 56 containing carbon dioxide and an aqueous unreacted methanol solution is discharged, on the anode side. On the cathode side, oxygen or air 57 is supplied and exhaust gas 58 containing water is discharged. In the fuel cell thus constituted, the amount of a reaction intermediate contained in the exhaust gas 58 can be reduced.

The fuel cell of the present invention has high performance because it uses the aforesaid composite catalyst, and the fuel cell also has characteristics that it is inexpensive as compared with a fuel cell using platinum alone as a catalyst and having the same performance.

In a more preferred embodiment of the present invention, the fuel cell can further include a reaction intermediate removing filter for a direct liquid fuel cell, which is for removing a reaction intermediate contained in a discharged matter from the electrode. By the use of such a reaction intermediate removing filter in combination, leakage of a reaction intermediate remaining in a slight amount to the outside of the fuel cell system can be prevented. In the fuel cell of the present invention, the amount of a reaction intermediate discharged is originally small, and therefore, the throughput capacity of the removing filter does not always need to be high. On that account, it is easy to select a removing filter having small pressure loss.

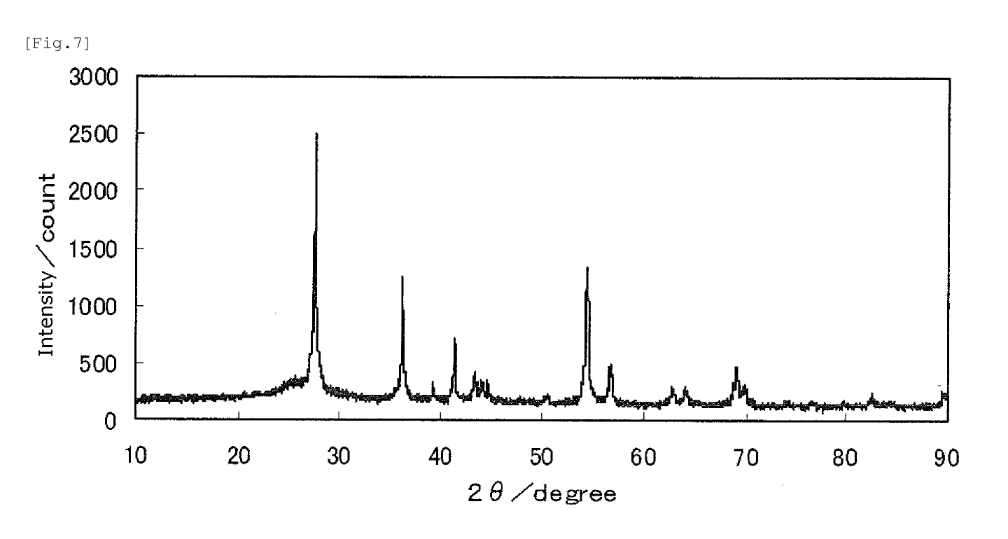

As such a reaction intermediate removing filter employable in the present invention, a reaction intermediate removing filter including a gas-liquid separation member for selectively allowing a gas component in the discharged matter from the electrode to permeate therethrough, and a catalyst part for allowing the gas component having permeated through the gas-liquid separation member to undergo oxidation combustion can be mentioned, and for example, such a reaction intermediate removing filter described in Patent Document 2 as illustrated in FIG. 6 can be used.

The reaction intermediate removing filter illustrated in FIG. 6 has a cylindrical case 62 arranged in a pipe 61 and a catalyst part 63 with which the case 62 is filled. By filling the case 62 with the catalyst part 63, leakage of an exhaust gas to the outside through a pathway other than the catalyst part 63 can be prevented. The case 62 also functions as a support for a gas-liquid separation member or the like. That is to say, the removing filter further includes a fall-off prevention member 64a, which is arranged at the opening of the case 62 on a front stage side (exhaust gas inflow side) and has a network structure for inhibiting fall-off of the catalyst from the catalyst part 63,

a fall-off prevention member 64b, which is arranged at the opening of the case 62 on a rear stage side (side where purified exhaust gas is discharged) and has a network structure for inhibiting fall-off of the catalyst from the catalyst part 63, and

a gas-liquid separation member 65 arranged on a more front stage side than the drop-off prevention member 64a in the case 62.

In the removing filter, a contact prevention member 66 having a network structure of larger mesh than that of the fall-off prevention members is arranged at the position externally apart from the rear stage side fall-off prevention member 64b by several mm or more so that direct contact with the removing filter may be avoided. Between the contact prevention member 66 and the catalyst fall-off prevention member 64b, a gas-liquid separation structure 67 for preventing leakage to the outside may be arranged as a protective measure against leakage of droplets from the catalyst part 63. Instead of arranging the gas-liquid separation structure 67, the contact prevention member 66 or the fall-off prevention member 64b may also serve as this structure.

In FIG. 6, an embodiment wherein the removing filter is arranged inside the pipe 61 is shown, but the removing filter may be arranged not inside the pipe 61 but in close contact with the end of the pipe 61.

The catalyst contained in the catalyst part 63 has only to be one having an ability to oxidize the reaction intermediate such as formaldehyde, formic acid or methyl formate to convert it to water and carbon dioxide. An example of such a catalyst is an anode catalyst. Specifically, it may be a publicly known one in which a precious metal catalyst such as platinum or silver is supported on activated carbon, ceramic or the like, and when platinum is used, it is preferably used as an alloy of platinum and ruthenium in order to inhibit poisoning. In order to prevent ignition of the carrier itself, it is desirable to support such a catalyst on a ceramic-based carrier.

When the catalyst part 63 is formed from catalyst particles, the pore diameters of the catalyst fall-off prevention members 64a and 64b must be made smaller than the mean particle diameter of the catalyst particles in order to inhibit outflow of the catalyst particles. The fall-off prevention members are preferably formed from materials that have high corrosion resistance to methanol and do not undergo thermal deformation at an operating temperature of a direct methanol fuel cell power generation device. On the other hand, when a catalyst part 63 capable of maintaining a given shape, such as a monolith, is used, the catalyst fall-off prevention member may not be provided.

As the gas-liquid separation member 65, for example, a water-repellent porous sheet is used. Examples of the water-repellent porous sheet include a porous sheet made of a fluororesin such as polytetrefluoroethylene (PTF) and a sheet obtained by subjecting a nylon mesh to water repellent treatment.

In the case where a reaction intermediate removing filter is incorporated into, for example, a fuel cell illustrated in FIG. 5, the reaction intermediate removing filter can be connected to at least an outlet of the exhaust gas 58, and if necessary, through a pipe. Further, the reaction intermediate removing filter can be also connected to an outlet of the waste liquid 56 likewise, in addition to the outlet of the exhaust gas 58. For example, when the reaction intermediate removing filter described in Patent Document 2 is used, a pipe is connected to both of the outlet of the exhaust gas 58 and the outlet of the waste liquid 56, and on the midway of the pipe, the exhaust gas 58 and the waste liquid 56 are made to flow together, and then they can be lead to the reaction intermediate removing filter.

Such a fuel cell of the present invention as described above can enhance performance of articles having at least one function selected from the group consisting of power generation function, light emission function, heat generation function, sound generation function, motor function, display function and charging function and having a fuel cell, particularly performance of portable articles. The fuel cell is preferably provided on a surface of an article or inside thereof.

Embodiments of the fuel cell of the present invention are specifically described below with reference to the following examples.

### EXAMPLES

The present invention is described below in more detail with reference to the following examples, but it should be construed that the present invention is in no way limited to those examples.

Various measurements in the examples and the comparative examples were carried out in the following manner.

[Analytical Method]

1. Powder X-Ray Diffraction

Powder X-ray diffraction of a sample was carried out by use of Rotaflex manufactured by Rigaku Denki Co., Ltd.

The number of diffraction peaks in the powder X-ray diffraction of each sample was counted by regarding a signal, which was detectable in a ratio (S/N) of signal (S) to noise (N) of 2 or more, as one peak.

Judgment of the noise (N) was carried out on the basis of a width of a baseline.

2. Elemental Analysis

Carbon: 0.1 g of a sample was weighed out, and measurement was carried out by EMIA-110 manufactured by Horiba, Ltd.

Nitrogen, oxygen: 0.1 g of a sample was weighed out and enclosed in a Ni-cup, and thereafter, measurement was carried out by an ON analytical device.

Transition metal element (titanium or the like): 0.1 g of a sample was weighed in a platinum dish, then an acid was added, and thermal decomposition was carried out. The thermal decomposition product was made constant-volume and then diluted, and determination was carried out by ICP-MS.

3. BET Specific Surface Area

A sample of 0.15 g was collected, and measurement of a specific surface area was carried out by a fully automatic BET specific surface area measuring device Macsorb (manufactured by Mountech Co., Ltd.). The pretreatment time and the pretreatment temperature were set to 30 minutes and 200° C., respectively.

In the following examples and comparative examples, the BET specific surface area is sometimes also referred to as a “specific surface area” simply.

### Reference Example 1

### Preparation of Anode

1. Preparation of Catalyst Ink for Anode

To 50 ml of pure water, 0.6 g of Pt-supported carbon (TEC10E70TPM, manufactured by Tanaka Kikinzoku Kogyo K.K.) was added, then 5 g of an aqueous solution (NAFION aqueous 5% solution, manufactured by Wako Pure Chemical Industries, Ltd.) containing a proton conductive material (NAFION (registered trademark): 0.25 g) was further added, and they were mixed for 1 hour by an ultrasonic dispersing machine (UT-106H type, manufactured by Sharp Manufacturing Systems Corporation) to give a catalyst ink (1) for anode.

2. Preparation of Electrode Having Anode Catalyst Layer

A gas diffusion layer (carbon paper TGP-H-060, manufactured by Toray Industries, Inc.) was immersed in acetone for 30 seconds to perform degreasing. After drying, the layer was immersed in an aqueous 10% polytetrafluoroethylene (also referred to as “PTFE” hereinafter) solution for 30 seconds. After drying at room temperature, the layer was heated at 350° C. for 1 hour, whereby a gas diffusion layer, in which PTFE had been dispersed inside the carbon paper to allow the layer to have water repellency, was obtained.

Next, a surface of the gas diffusion layer having a size of 5 cm×5 cm was coated with the catalyst ink (1) for anode prepared in the above 1, at 80° C. by use of an automatic spray coating device (manufactured by SAN-EI TECH Ltd.). Spray coating was repeatedly carried out to give an electrode having an anode catalyst layer (1) containing Pt in an amount of 1 mg/cm² per unit area.

### Example 1

### 1. Preparation of Membrane Electrode Assembly

A membrane electrode assembly having constitution shown in FIG. 1 was prepared.

1) Production of Catalyst Carrier (TiFeCNO)

First, 10.043 g of glycine was dissolved in 120 ml of distilled water to give a first liquid.

To 5.118 ml of acetylacetone, 10 ml of titanium tetraisopropoxide was slowly dropwise added with ice cooling, and 0.5818 g of iron(II) acetate and 16 ml of acetic acid were further added to give a second liquid.

The second liquid was added to the first liquid so as not to form a precipitate. Thereafter, the container from which the second liquid had been taken out was washed with 16 ml of acetic acid, and this wash liquid was also added to the first liquid.

The resulting transparent solution was evaporated to dryness using an evaporator to give 14.8 g of a precursor.

In a 4 vol % hydrogen/nitrogen atmosphere, 1.0 g of the resulting precursor was heat-treated at 890° C. for 15 minutes to give 0.28 g of TiFeCNO (also referred to as a “carrier (1)” hereinafter). The composition of the carrier (1) constituted of the constituent elements was Ti_{0.91}Fe_{0.09}C_{2.70}N_{0.07}O_{1.30}, and the specific surface area of the carrier (1) was 244 m²/g.

In FIG. 7, a powder X-ray diffraction spectrum of the carrier (1) is shown.

2) Production of 5 wt % Pd-Supported TiFeCNO

To 150 ml of distilled water, 612 mg of TiFeCNO (carrier (1)) was added, and they are shaken for 30 minutes by an ultrasonic washing machine. While stirring this suspension, the liquid temperature was maintained at 80° C. by a hot plate.

Separately from the suspension, a solution was prepared in advance in which 529.2 mg (corresponding to 32.3 g of palladium) of tetraamminepalladium(II) chloride (manufactured by Wako Pure Chemical Industries, Ltd.) had been dissolved in 52 ml of distilled water.

This solution was added to the above suspension over a period of 30 minutes (the liquid temperature was maintained at 80° C.). Thereafter, the resulting suspension was stirred for 2 hours at a liquid temperature of 80° C.

Next, to the resulting suspension was slowly added 1M sodium hydroxide until pH of the suspension became 11, and thereafter, 1M sodium borohydride was slowly added in such an amount (ratio between sodium borohydride and the metal component=10:1 or higher in terms of metal molar ratio) that the metal component (i.e., tetraamminepalladium(II) chloride) was sufficiently reduced. Thereafter, the suspension was stirred for 1 hour at a liquid temperature of 80° C. After the reaction was completed, the suspension was cooled and filtered.

The resulting powder was heat-treated at 300° C. for 1 hour in a 4 vol % hydrogen/nitrogen atmosphere to give 644 mg of 5 wt % Pd-supported TiFeCNO (also referred to as a “catalyst (1)” hereinafter) as a composite catalyst. The specific surface area of the catalyst (1) was 204 m²/g.

### 3. Evaluation of Unit Cell

To a mixed solvent of 25 ml of isopropyl alcohol (manufactured by Wako Pure Chemical Industries, Ltd.) and 25 ml of ion-exchanged water, 0.355 g of the catalyst (1), and 0.089 g of carbon black (Ketjen Black EC300J, manufactured by Lion Corporation) as an electron conductive material were added, then 5.325 g of an aqueous 5% solution (manufactured by Wako Pure Chemical Industries, Ltd.) of NAFION (registered trademark) as a proton conductive material was further added, and they were mixed for 1 hour by an ultrasonic dispersing machine (UT-106H type, manufactured by Sharp Manufacturing Systems Corporation) to give a catalyst ink (1) for cathode.

To ion-exchanged water containing a surface active agent, copper(II) chloride which was a precursor compound of a reaction intermediate oxidation catalyst and polytetrafluoroethylene were added, they were well mixed, and thereafter, this solution was placed in a polyethylene bag capable of being closed. In this bag, carbon paper (GDL24BC, manufactured by SGL Carbon Group) (also referred to as “GDL” hereinafter) having a size of 5 cm×5 cm was placed and allowed to stand still for 1 hour at room temperature, to impregnate the carbon paper with the solution containing copper chloride and polytetrafluoroethylene. Thereafter, the carbon paper was taken out, dried at 120° C. for 1 hour in the atmosphere and further calcined at 350° C. for 1 hour in the atmosphere to remove the surface active agent. Thereafter, the carbon paper was treated at 300° C. in a hydrogen atmosphere to forma reaction intermediate oxidation catalyst of copper in a metal state, whereby a cathode diffusion layer (1) used as the cathode diffusion layer 15 of the present invention was obtained.

A surface of the cathode diffusion layer (1) was coated with the catalyst ink (1) for cathode at 80° C. by use of an automatic spray coating device (manufactured by SAN-EI TECH Ltd.) to give an electrode (1) (also referred to as a “cathode (1)” hereinafter) having a cathode catalyst layer on the surface of GDL containing the reaction intermediate oxidation catalyst. Coating with the catalyst ink was carried out so that the mass of the precious metal based on 1 cm² of the electrode might become 1.0 mg.

A NAFION (registered trademark) membrane (N-212, manufactured by Du Pont), the cathode (1), and the electrode (also referred to as “anode (1)” hereinafter) having the anode catalyst layer (1) prepared in Reference Example 1 were prepared as an electrolyte membrane, a cathode and an anode, respectively. A membrane electrode assembly (1) (also referred to as “MEA (1)” hereinafter), in which the electrolyte membrane was arranged between the cathode and the anode, was prepared in the following manner.

The electrolyte membrane was interposed between the cathode (1) and the anode (1), and they were subjected to thermocompression bonding at a temperature of 140° C. and a pressure of 3 MPa over a period of 6 minutes by use of a hot press so that the cathode catalyst layer and the anode catalyst layer might come into close contact with the electrolyte membrane, whereby MEA was prepared.

### 4. Preparation of Fuel Cell

The MEA (1) obtained in the above 3 was interposed between two sealing materials (gaskets), two separators with gas flow path, two collectors and two rubber heaters and was fixed to them with a bolt to give a unit cell (1) (also referred to as a “fuel cell (1)” hereinafter) (cell area: 5 cm²) of a polymer electrolyte fuel cell.

This fuel cell (1) has the same constitution as that of a fuel cell shown in FIG. 5.

### 5. Evaluation of Fuel Cell

The fuel cell (1), an anode humidifier and a cathode humidifier were temperature-controlled to 90° C., 90° C. and 50° C., respectively. To the anode side was supplied an aqueous 3 mass % methanol solution as a fuel at a flow rate of 3 mL/min, to the cathode side was supplied air as an oxidizing agent at a flow rate of 100 mL/min, and a current-voltage property in the unit cell was measured in an environment of normal pressure. On this occasion, with regard to the exhaust gas 58 from the cathode side, the amounts of formaldehyde, formic acid and methyl formate discharged were measured. From this, the total amount of formaldehyde, formic acid and methyl formate discharged based on 1 Wh of power generation was not more than 1/10 (in terms of a mass ratio) that in the later-described Comparative Example 1.

By taking such constitution, the amount of the reaction intermediate discharged from the cathode can be decreased in the cathode diffusion layer.

### Example 2

A membrane electrode assembly (referred to as “MEA (2)” hereinafter) and a unit cell (referred to as a “fuel cell (2)” hereinafter) were prepared in the same manner as in Example 1, except that palladium(II) chloride was used as a precursor compound of a reaction intermediate oxidation catalyst, instead of copper(II) chloride, and a small amount of hydrochloric acid was further added to ion-exchanged water to such an extent that the palladium(II) chloride was dissolved.

With regard to the fuel cell (2), the same measurement as in Example 1 was carried out. From this, the total amount of formaldehyde, formic acid and methyl formate discharged based on 1 Wh of power generation was not more than 1/30 (in terms of a mass ratio) that in the later-described Comparative Example 1.

Also by taking such constitution, the amount of the reaction intermediate discharged from the cathode can be decreased in the cathode diffusion layer.

### Example 3

### 1. Preparation of Membrane Electrode Assembly

A membrane electrode assembly having constitution shown in FIG. 4 was prepared.

A cathode diffusion layer (3a) used as the cathode diffusion layer first layer 45 of the cathode diffusion layer 47 was obtained in the same preparation process as that for the cathode diffusion layer (1) in Example 1, except that copper (II) chloride was not added, and heat treatment in a hydrogen atmosphere was not carried out.

Next, a cathode diffusion layer (3b) used as the cathode diffusion layer second layer 46 of the cathode diffusion layer 47 was obtained in the same preparation process as that for the cathode diffusion layer (1) in Example 1.

One surface of the cathode diffusion layer (3a) was coated with the catalyst ink (1) for cathode obtained in Example 1, and on the other surface of this cathode diffusion layer (3a), the cathode diffusion layer (3b) was superposed to give an electrode (3) (also referred to as a “cathode (3)” hereinafter) constituted of a cathode catalyst layer, the cathode diffusion layer (3a) and the cathode diffusion layer (3b). Coating with the catalyst ink was carried out so that the mass of the precious metal based on 1 cm² of the electrode might become 1.0 mg.

In the present example, a membrane electrode assembly (referred to as “MEA (3)” hereinafter) was prepared in the same manner as in Example 1, except that the cathode (3) was used instead of the cathode (1).

### 2. Preparation of Fuel Cell

Preparation of a unit cell (referred to as a “fuel cell (3)” hereinafter) was carried out in the same manner as in Example 1, except that the MEA (3) was used instead of the MEA (1).

With regard to the fuel cell (3), the same measurement as in Example 1 was carried out. From this, the total amount of formaldehyde, formic acid and methyl formate discharged based on 1 Wh of power generation was not more than 1/20 (in terms of a mass ratio) that in the later-described Comparative Example 1.

By taking such constitution, the amount of the reaction intermediate discharged from the cathode can be decreased in the cathode diffusion layer. Further, by allowing the cathode diffusion layer to have a multi-layer structure and providing the cathode diffusion layer first layer containing no reaction intermediate oxidation catalyst so as to be in contact with the cathode, elution of copper that is a reaction intermediate oxidation catalyst can be inhibited, and lowering of output of the fuel cell can be inhibited.

### Example 4

With regard to the fuel cell (1) prepared in Example 1, a reaction intermediate removing filter having a structure shown in FIG. 6 was connected to the outlet of the waste liquid 56 and the outlet of the exhaust gas 58 through the merging passage in accordance with the method described in Example 1 of Patent Document 2, whereby a fuel cell (referred to as a “fuel cell (4)” hereinafter) with a reaction intermediate removing filter was prepared.

Here, the removing filter used in the present example is described.

For the catalyst part 3, a catalyst in a cylindrical form having an inner diameter of 6 mm and a length of 5 mm, which was obtained by molding a catalyst containing Pt of about 100 (μg/cc) per unit bulk volume and Ru that were supported on activated carbon having a particle diameter of 500 to 250 μm, was used. The case 2 was prepared from aluminum. An aluminum pipe which was the case 2 was filled with the catalyst part 3 so that anode and cathode exhaust gases might flow into the catalyst part perpendicularly to a toric surface of the catalyst part.

For the catalyst fall-off prevention members 4a and 4b, a nylon mesh having an opening diameter of 100 μm was used, and these members were fixed to the aluminum pipe which was the case 2.

As the gas-liquid separation member, a Teflon (registered trademark) sheet having a pore diameter of 0.5 mm and an interval between pores of 1 mm was used.

Dry air was allowed to pass through the removing filter having such constitution at 100 ml/min, and as a result, the pressure loss at the removing filter was about 50 Pa.

Further, with regard to the fuel cell (4), the same measurement as in Example 1 was carried out. From this, the total amount of formaldehyde, formic acid and methyl formate discharged based on 1 Wh of power generation was not more than 1/15 (in terms of a mass ratio) that in the later-described Comparative Example 1.

Also by taking such constitution, the amount of the reaction intermediate discharged from the cathode exhaust gas outlet can be decreased.

### Comparative Example 1

### 1) Production of 5 wt % Pt-Supported Carbon (Pt/C) Catalyst

To 150 ml of distilled water, 612 mg of carbon black (Ketjen Black EC300J, manufactured by Ketjen Black International Co., Ltd.) was added, and they were shaken for 30 minutes by an ultrasonic washing machine. While stirring this suspension, the liquid temperature was maintained at 80° C. by a hot plate.

Separately from the suspension, a solution was prepared in advance in which 84.5 mg (corresponding to 32.2 mg of platinum) of chloroplatinic acid hexahydrate had been dissolved in 52 ml of distilled water.

This solution was added to the above suspension over a period of 30 minutes (the liquid temperature was maintained at 80° C.). Thereafter, the resulting suspension was stirred for 2 hours at a liquid temperature of 80° C.

Next, to the resulting suspension was slowly added 1M sodium hydroxide until pH of the suspension became 11, and thereafter, 1M sodium borohydride was slowly added to the suspension in such an amount (ratio between sodium borohydride and the metal component=10:1 or higher in terms of metal molar ratio) that the metal component (i.e., chloroplatinic acid hexahydrate) was sufficiently reduced. Thereafter, the suspension was stirred for 1 hour at a liquid temperature of 80° C. After the reaction was completed, the suspension was cooled and filtered.

The resulting powder was heat-treated at 300° C. for 1 hour in a 4 vol % hydrogen/nitrogen atmosphere to give 644 mg of a 5 wt % Pt-supported carbon (Pt/C) catalyst (also referred to as a “catalyst (5)” hereinafter). The specific surface area of the catalyst (5) was 793 m²/g.

### 2) Preparation of Fuel Cell

A membrane electrode assembly (referred to as “MEA (5)” hereinafter) and a unit cell (referred to as a “fuel cell (5)” hereinafter) were prepared in the same manner as in Example 1, except that the 5 mass % platinum-supported carbon black (also referred to as “catalyst (5)” hereinafter) was used instead of the catalyst (1).

With regard to the fuel cell (5), measurement on the exhaust gas 58 from the cathode side was carried out under the same conditions as in Example 1. From this, the total amount of formaldehyde, formic acid and methyl formate discharged based on 1 Wh of power generation was determined. The resulting amount discharged based on 1 Wh of power generation was taken to be 1, and comparison with other examples and comparative examples was carried out.

### Comparative Example 2

A membrane electrode assembly (referred to as “MEA (6)” hereinafter) and a unit cell (referred to as a “fuel cell (6)” hereinafter) were prepared in the same manner as in Example 1, except that a cathode diffusion layer (6), which had been prepared in the same manner as that for the cathode diffusion layer (1) except that no polytetrafuoroethylene had been introduced, was used instead of the cathode diffusion layer (1).

With regard to the fuel cell (6), measurement was carried out in the same manner as in Example 1. From this, the total amount of formaldehyde, formic acid and methyl formate discharged based on 1 Wh of power generation was determined, and as a result, the amount in terms of a mass ratio was larger than that of Comparative Example 1.

In the case of such constitution, the reaction intermediate oxidation catalyst in the cathode diffusion layer is immersed in water. Therefore, the oxidation efficiency of the reaction intermediate is low, and the amount of the reaction intermediate discharged from the fuel cell cannot be greatly decreased.

### REFERENCE SIGNS LIST

11, 41: anode diffusion layer
12, 42: anode catalyst layer
13, 43: solid polymer electrolyte membrane
14, 44: cathode catalyst layer
15, 47: cathode diffusion layer
21, 31: base
22, 32: reaction intermediate oxidation catalyst
23, 33: water-repellent resin
34: microporous layer
45: cathode diffusion layer first layer
46: cathode diffusion layer second layer
51: anode collector
52: cathode collector
53: membrane electrode assembly
54: external circuit
55: aqueous methanol solution
56: waste liquid
57: oxygen (air)
58: exhaust gas
61: pipe
62: case
63: catalyst part
64a, 64b: fall-off prevention member
65: gas-liquid separation member
66: contact prevention member
67: gas-liquid separation structure

1. A membrane electrode assembly comprising an anode, a cathode and a solid polymer electrolyte membrane and having constitution in which the solid polymer electrolyte membrane is interposed between the anode and the cathode, wherein
the cathode has a cathode catalyst layer and a cathode diffusion layer that is arranged on a surface of the cathode catalyst layer, said surface being on the opposite side to the solid polymer electrolyte membrane side,
the cathode catalyst layer contains an oxygen reduction catalyst composed of composite particles each of which is constituted of a catalyst metal and a catalyst carrier,
the catalyst metal contains palladium or a palladium alloy,
the catalyst carrier contains, as constituent elements,
a transition metal element M1 that is at least one selected from the group consisting of titanium, zirconium, niobium and tantalum,
a transition metal element M2 other than the transition metal element M1,
carbon,
nitrogen, and
oxygen,
the ratio of the number of atoms among the transition metal element M1, the transition metal element M2, carbon, nitrogen and oxygen (transition metal element M1:transition metal element M2:carbon:nitrogen:oxygen) is (1-a):a:x:y:z (with the proviso that a, x, y and z are numbers of 0<a≦0.5, 0<x≦7, 0<y≦2 and 0<z≦3), and
the cathode diffusion layer contains an oxidation catalyst and a water-repellent resin.

2. The membrane electrode assembly as claimed in claim 1, wherein the transition metal element M2 is at least one selected from iron, nickel, chromium, cobalt, vanadium and manganese.

3. The membrane electrode assembly as claimed in claim 1, wherein the oxidation catalyst contained in the cathode diffusion layer is at least one selected from platinum, palladium, copper, silver, tungsten, molybdenum, iron, nickel, cobalt, manganese, zinc and vanadium.

4. The membrane electrode assembly as claimed in claim 1, wherein the water-repellent resin contained in the cathode diffusion layer is at least one selected from polytetrafluoroethylene, polychlorotrifluoroethylene, poly(vinylidene fluoride), poly(vinyl fluoride), a perfluoroalkoxyfluorine resin, a tetrafluoroethylene/hexafluoropropylene copolymer, an ethylene/tetrafluoroethylene copolymer, an ethylene/chlorotrifluoroethylene copolymer, polyethylene, polyolefin, polypropylene, polyaniline, polythiophene and polyester.

5. The membrane electrode assembly as claimed in claim 1, wherein the cathode catalyst layer further contains an electron conductive substance.

6. A fuel cell comprising the membrane electrode assembly as claimed in claim 1.

7. The fuel cell as claimed in claim 6, which further comprises a reaction intermediate removing filter for a direct liquid fuel cell, said reaction intermediate removing filter being for removing a reaction intermediate contained in a discharged matter from the electrode.

8. The fuel cell as claimed in claim 7, wherein the reaction intermediate removing filter for a direct liquid fuel cell comprises:
a gas-liquid separation member for selectively allowing a gas component in the discharged matter to permeate therethrough, and
a catalyst part for allowing the gas component having permeated through the gas-liquid separation member to undergo oxidation combustion.

9. The fuel cell as claimed in claim 6, which is a direct methanol fuel cell.
